(19) United States
(12) Patent Application Publication
(10) Pub. No.: US 2006/0091061 A1
(43) Pub. Date: May 4, 2006

(54) Filter assembly with sealing system

(75) Inventor: Gene W. Brown, Franklin, TN (US)

Correspondence Address: LEYDIG VOIT & MAYER, LTD.;(ROCKFORD OFFICE), TWO PRUDENTIAL PLAZA, SUITE 4900, 180 NORTH STESTON AVENUE, CHICAGO, IL, 60601-6780, US

(73) Assignee: Baldwin Filters, Inc., Kearney, NE (US)

(21) Appl. No.: 10/979,783

(22) Filed: Nov. 2, 2004

(51) Int. Cl. B01D 27/00

(52) U.S. Cl. 210/440

(57) ABSTRACT

A filter assembly including a tubular filter housing and a removable filter element for use therein that employ a compressible seal element. The seal element connected to the rest of the filter element and located to sealingly engage the filter housing. In an aspect, a separate, rigid support member is disclosed that supports the seal element against the filter housing to improve the seal and prevent distortion of the compressible seal material. In another aspect, an end cap connecting the seal element to the rest of the filter housing includes an extending leg having improved features for retaining the seal element to the end cap. In another aspect, the seal element can be retentively received in a slotted member attached to the filter element.

### FIELD OF THE INVENTION

This invention pertains generally to fluid filtration and more particularly to filter assemblies which include filter housings and removable filter elements.

### BACKGROUND OF THE INVENTION

Filtration devices and systems are employed in a wide range of applications for filtering contaminants from various process fluids. For example, it is known to pass air or similar gasses through filter assemblies that enclose filtration media such as filter paper to remove dust and other contaminants. The filtration media is typically enclosed within a housing that is permanently fixated within a larger overall process system that utilizes the filtered fluids. Desirably, to prevent reduced filtration or clogging, the filter assembly is constructed to facilitate the removal and replacement of the filtration media from the permanently fixated housing. For this reason, the filtration media is typically configured into removable filter elements or filter cartridges. To enable removal of a filter element from the filter housing, typically a clearance or gap is provided between the two components. To cause process fluids to pass through the filtration media rather than around any clearance between the filter element and filter housing, the filter element is often provided with a seal that abuts against the filter housing. One particular filter element provided with a seal is disclosed in U.S. Pat. No. 6,610,117 (Gieseke), herein incorporated by reference.

### BRIEF SUMMARY OF THE INVENTION

The invention provides a filter assembly and a removable filter element for use therein that employ a compressible seal element. In an aspect, the seal element is spaced from the rest of the filter element and connected directly or indirectly thereto by a rigid end cap. Hence, when the filter element is inserted into a filter housing having a narrowed or stepped-in surface, the seal element abuts against that surface creating a seal. The sealing engagement between the seal element and the filter housing prevents process fluids from flowing through any unoccupied clearances between the filter element and filter housing and thereby avoid filtration. In an aspect, the invention provides a separate, rigid support member that supports the seal element against the filter housing to improve the seal and prevent distortion of the compressible seal material. In another aspect, the invention provides an end cap for connecting the seal element to the rest of the filter housing which is configured for improved attachment to the seal element. Accordingly, the seal element is sufficiently restrained against detaching from the end cap and the rest of the filter element. In further aspects, the seal element can be received into a slot or groove for retention, and the seal element can be located at various places along the filter element. These and other advantages and features of the invention will be apparent from the following drawings and detailed description.

### BRIEF DESCRIPTION OF THE DRAWINGS

The accompanying drawings incorporated in and forming a part of the specification illustrate several aspects of the invention, and together with the description serve to explain the principles of the invention. In the drawings:

FIG. 1 is a cross-sectional view of a filter assembly including a filter element employing a seal element engaging a filter housing that is designed in accordance with the teachings of the invention.

FIG. 2 is an exploded view of the filter element including filter media comprised of a multilayered corrugated sheet including a corrugated or fluted layer and a cover layer, a grill plate, and an end cap connected to the seal element.

FIG. 3 is a detailed view of the circled area indicated in FIG. 1 illustrating the seal element connected to the rest of the filter element via the end cap and supported against the filter housing (shown in dashed lines) by a support member.

FIG. 4 is a detailed view of the area indicated by circle 4 in FIG. 3 showing the seal element attached to the end cap by a plurality of forks.

FIG. 5 is a detailed view of the circled area indicated in FIG. 1 illustrating another embodiment wherein the seal element is mechanically attached to an end cap and supported against the filter housing (shown in dashed lines) by a support member.

FIG. 6 is a detailed view of the circled area indicated in FIG. 1 illustrating another embodiment wherein the seal element is mechanically attached to an end cap and supported against the filter housing (shown in dashed lines) by a support member having a strengthening rib.

FIG. 7 is a detailed view of the circled area indicated in FIG. 1 illustrating another embodiment wherein the seal element is hooked to the rest of the filter element by an end cap and supported against the filter housing (shown in dashed lines) by a support member.

FIG. 8 is a detailed view of the circled area indicated in FIG. 1 illustrating another embodiment wherein the seal element is hooked to the rest of the filter element by an end cap and mechanically attached to a support member supporting the seal element against the filter housing (shown in dashed lines).

FIG. 9 is a detailed view of the circled area indicated in FIG. 1 illustrating another embodiment wherein the seal element is hooked to the rest of the filter element by an end cap and is mechanically attached via a hollow knob to a support member supporting the seal element against the filter housing (shown in dashed lines).

FIG. 10 is a detailed view of the circled area indicated in FIG. 1 illustrating another embodiment wherein the seal element is hooked to the rest of the filter element by an end cap and is mechanically attached via a slotted hollow knob to a support member supporting the seal element against the filter housing (shown in dashed lines).

FIG. 11 is a detailed view of the circled area indicated in FIG. 1 illustrating another embodiment wherein the seal element is mechanically attached to the end cap and supported against the filter housing (shown in dashed lines) by a support member including a depending rib.

FIG. 12 is a detailed view of the circled area indicated in FIG. 1 illustrating another embodiment wherein the seal element is mechanically attached to the end cap and supported against the filter housing (shown in dashed lines) by a support member inserted between the seal element.

FIG. 13 is a detailed view of the circled area indicated in FIG. 1 illustrating another embodiment wherein the seal element is mechanically attached to the end cap and supported against the filter housing (shown in dashed lines) by a support member that engages a grill plate.

FIG. 14 is a detailed view of the circled area indicated in FIG. 1 illustrating another embodiment wherein the seal element is attached to a support member integral with a grill plate and connected to the rest of the filter element by an end cap.

FIG. 15 is a detailed view of the circled area indicated in FIG. 1 illustrating another embodiment wherein the seal element is connected to an end cap having a wave-like leg extending beyond the filter media.

FIG. 16 is a detailed view of the circled area indicated in FIG. 1 illustrating another embodiment wherein the seal element is connected to an end cap having a curved leg extending beyond the filter media.

FIG. 17 is a detailed view of the circled area indicated in FIG. 1 illustrating another embodiment wherein the seal element is connected to an end cap having a leg extending beyond the filter media that includes an enlarged lobe.

FIG. 18 is a detailed view of the circled area indicated in FIG. 1 illustrating another embodiment wherein the seal element is connected to an end cap with a tapered leg extending beyond the filter media that includes a notched surface.

FIG. 19 is a detailed view of the circled area indicated in FIG. 1 illustrating another embodiment wherein the seal element is connected to an end cap having an inward angled leg extending beyond the filter media.

FIG. 20 is a detailed view of the circled area indicated in FIG. 1 illustrating another embodiment wherein the seal element is connected to an end cap having an outward angled leg with a flange extending beyond the filter media.

FIG. 21 is a detailed view of the circled area indicated in FIG. 1 illustrating another embodiment wherein the seal element is connected to an end cap taped to the filter media.

FIG. 22 is a detailed view of the circled area indicated in FIG. 1 illustrating another embodiment wherein the seal element is connected to an end cap having two diverging legs extending beyond the filter media.

FIG. 23 is a detailed view of the circled area indicated in FIG. 1 illustrating another embodiment wherein the seal element is connected to an end cap having a plurality of posts and is supported by a support member against the filter housing (shown in dashed lines).

FIG. 24 is a detailed view of the circled area indicated in FIG. 1 illustrating another embodiment wherein the seal element is connected to an end cap having a plurality of posts and is supported against the filter housing (shown in dashed lines).

FIG. 25 is a detailed view of the circled area indicated in FIG. 1 illustrating another embodiment wherein the seal element is connected to an end cap having a plurality of posts and is supported by a support member against the filter housing (shown in dashed lines).

FIG. 26 is a detailed view of the circled area indicated in FIG. 1 illustrating another embodiment wherein the seal element is connected to an end cap having a plurality of posts and a raised shoulder portion and is supported against the filter housing (shown in dashed lines).

FIG. 27 is a detailed view of the circled area indicated in FIG. 1 illustrating another embodiment wherein the seal element is connected to an end cap having a plurality of posts and a slanted portion and is supported against the filter housing (shown in dashed lines).

FIG. 28 is a detailed view of the circled area indicated in FIG. 1 illustrating another embodiment wherein the seal element is received in a slotted member formed integrally with the end cap and is supported against the filter housing (shown in dashed lines).

FIG. 29 is a detailed view of the circled area indicated in FIG. 1 illustrating another embodiment wherein the seal element is received in a slotted member separated from the end cap and is supported against the filter housing (shown in dashed lines).

FIG. 30 is a detailed view of the circled area indicated in FIG. 1 illustrating another embodiment wherein the seal element is received in a slotted member formed integrally with the grill plate and is supported against the filter housing (shown in dashed lines).

FIG. 31 is a detailed view of the circled area indicated in FIG. 1 illustrating another embodiment wherein the seal element is connected directly to the sidewall of the filter media and is supported against the filter housing (shown in dashed lines).

FIG. 32 is a detailed view of the circled area indicated in FIG. 1 illustrating another embodiment wherein the seal element and end cap are connected to the sidewall of the filter media and is supported against the filter housing (shown in dashed lines).

FIG. 33 is a detailed view of the circled area indicated in FIG. 1 illustrating another embodiment wherein the seal element is located proximate the inlet of the filter housing.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

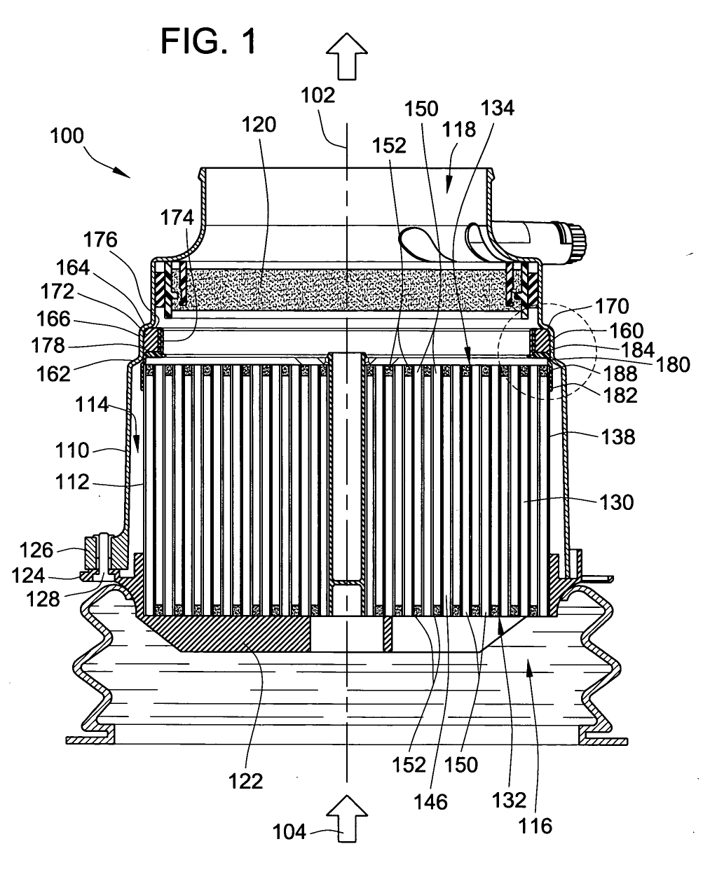

Now referring to the drawings, wherein like reference numbers refer to like elements, there is illustrated in FIG. 1 an example of a filter assembly 100 in which fluids, and particularly gasses such as air, can flow through for filtration. The filter assembly 100 includes a filter housing 110 defining an interior volume 114 that can accommodate a filter element 112. The filter housing 110 is generally tubular in shape and extends along an axis line 102. To provide access the interior volume 114, the filter housing 110 also includes an inlet 116 formed at a first end of the tubular housing and an axially spaced-apart outlet 118 formed at a second end of the housing. Because the axially opposed arrangement of the inlet 116 and outlet 118 will cause fluid to flow along the direction of the axis line 102 as indicated by arrows 104, this type of filter assembly 100 is often referred to as a “straight-through flow” filter assembly. In various embodiments, the filter assembly 100 can include a safety filter 120 located downstream of the primary filter element 112 proximate the outlet 118. Fluids from the filter element 112 are therefore directed to the safety filter 120 for further filtration prior to exiting the filter assembly 100.

To receive the filter element 112 in the internal volume 114, the filter element can be axially inserted through the inlet 116 of the filter housing 110. In the preferred and illustrated embodiment, both the filter housing 110 and filter element 112 are generally cylindrical in shape and coaxially arranged about the axis line 102, with the filter housing having a larger diameter than the filter element to provide a sliding or clearance fit. However, as will be appreciated by those of skill in the art, the tubular filter housing 110 and filter element 112 can be provided in other shapes such as, for example, oval and rectangular. Accordingly, geometric references such as “annular,” “ring-shaped” and the like are intended to encompass these and other shape alternatives.

To releasably secure the removable filter element 112 to the filter housing 110, in the illustrated embodiment the filter element includes an inlet cover 122 that extends over the inlet 116 when the filter element is inserted into the internal volume 114. The inlet cover 122 includes one or more radially outward extending flanges 124 that can abut against corresponding flanges 126 located at and projecting from the inlet 116 of the filter housing 110. Threaded fasteners 128 can be threadably received in threaded holes disposed through the respective flanges. Accordingly, to remove a clogged or dirty filter element 112, the threaded fasteners are undone and the filter element is pulled in the axial direction from the filter housing 110.

Attached to and extending from the inlet cover 122 into the internal volume 114 is the filter media 130 that actually performs the filtration of the fluids. In the illustrated embodiment, the filter media 130 is generally cylindrical and extends between a circular upstream face 132 and a spaced-apart, respectively circular downstream face 134. When properly inserted into the filter housing 110, the downstream face 134 is oriented toward the outlet 118 while the upstream face 132 is located proximate the inlet 116. Accordingly, as illustrated by the arrows 104, fluids passing through the filter assembly 100 will impinge upon the upstream face 132, filtrate through the filter media 130, and exit through the downstream face 134. The filter media 130 additionally includes a cylindrically shaped, peripheral sidewall 138 extending between the circular upstream and downstream faces 132, 134.

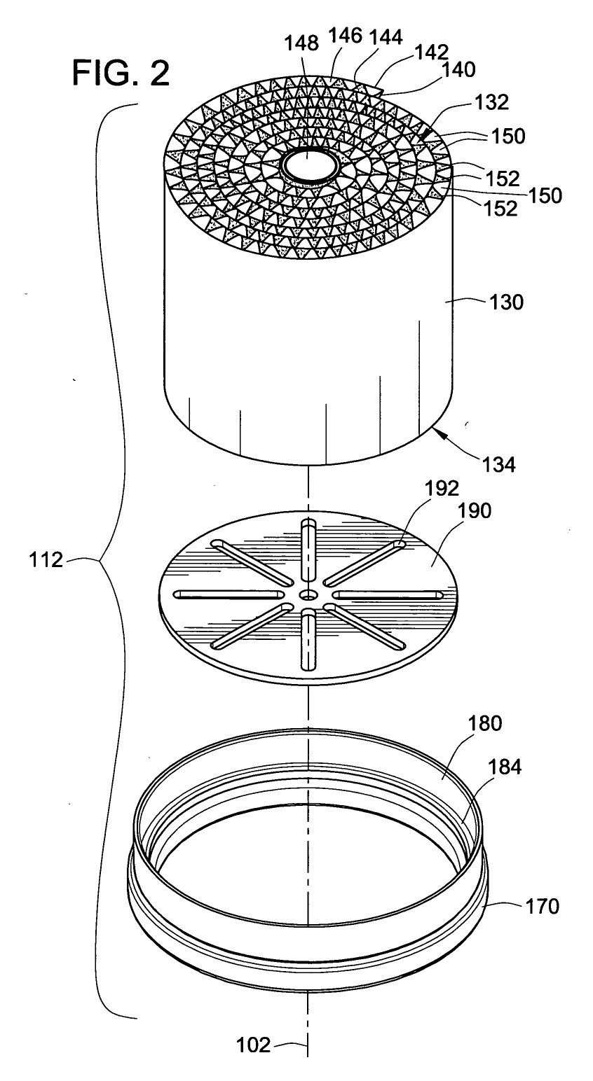

Preferably, the filter media 130 is constructed from wrapped or wound layers of a corrugated, multilayered sheet. For example, referring to FIG. 2, the multilayered sheet 140 of this construction is made from a planar layer 142 and a corrugated layer 144, both made from a fluid permeable filter paper material. The corrugated layer 144 is laid over and adhered to the planar layer 142 so that the corrugations form a plurality of parallel fluted channels 146. To produce the cylindrical shape of the filter media 130, the multilayered sheet 140 is spiral wound about a central rod 148 in radially increasing layers so that the channels 146 extend between the upstream and downstream faces 132, 134. In an embodiment, the filter media 130 can be wrapped in an outermost, adhesive layer that holds the spiral-wound, multilayered sheet 140 together.

To cause the fluids to pass through the planar and corrugated layers of filter paper 142, 144 and thereby remove impurities, the each of the fluted channels 146 is configured with either an opening 150 or a plug 152 at its respective upstream and downstream faces 132, 134. For example, as illustrated in FIG. 1, a particular channel 146 that has an opening 150 at the upstream face 132 will also have a plug 152 at the downstream face 134. The adjacent channel will be oppositely configured. Accordingly, fluids from the inlet 116 will readily pass into those channels 146 that are unplugged at the upstream face 132. Because those same channels 146 are plugged at the downstream face 134, the fluids must proceed through the filter paper layers into a channel unplugged at the downstream face 134. To plug a particular channel, a drop of adhesive can be inserted into the channel.

To ensure that fluids flow through the filter media 130 rather than any unoccupied portion of the internal volume 114 remaining between the filter media and tubular filter housing 110 and thereby avoid filtration, the filter element 112 proximate the downstream face 134 is configured to abut against a stepped surface 160 formed into the filter housing. The stepped surface 160 includes a first annular shoulder portion 162 and a second annular shoulder portion 164 that are axially spaced-apart by an annular intermediate portion 166. The first and second shoulder portions 162, 164 and the intermediate portion 166 are all concentric about the axis line 102 with the intermediate portion extending between the shoulder portions in a generally parallel orientation with the axis line. In the illustrated embodiment, the stepped surface 160 thereby radially reduces the diameter of the cylindrical filter housing 110.

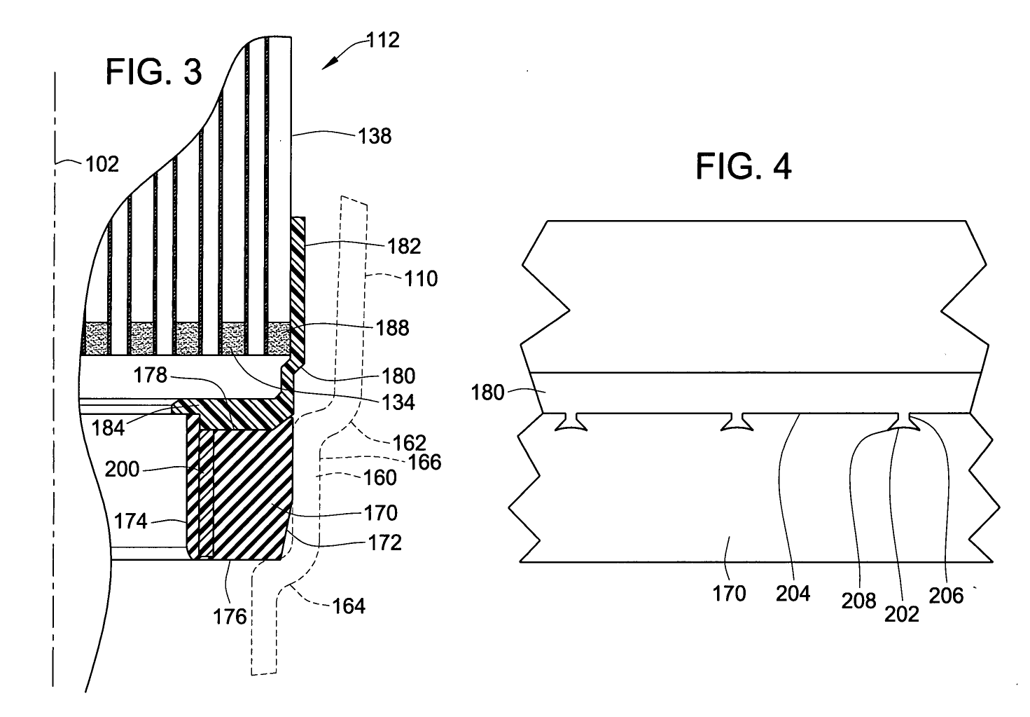

The filter element 112 also includes a compressible seal element 170 that creates a seal between the stepped surface 160 and the filter element when the filter element is inserted into and abuts against the filter housing 110. The seal element 170 is shaped as a ring-like structure that, in the cylindrical embodiment of the filter housing 110 and filter element 112, extends annularly about the axis line 102. As illustrated in FIG. 3, the cross-sectional shape of the seal element 170 itself is generally rectangular and includes a radially outward directed sealing surface 172, a generally parallel and radially inward directed inner surface 174, and generally parallel, spaced-apart top and bottom surfaces 176, 178. The seal element 170 can be made from any suitable material including, for example, molded urethane, nitrile rubber, ethylene propylene or other synthetic rubbers. In fact, the material for the seal element, like the filter paper comprising the filter media, can be selected in response to the fluid or gas to be filtered in a particular application.

To engage the seal element 170 and the stepped surface 160 in a manner that creates the seal, the seal element is axially spaced-apart from the downstream face 134. Therefore, when the filter element 112 is axially inserted into the filter housing 110, the sealing surface 172 of the seal element 170 and intermediate portion 166 of the stepped surface 160 slide into contact each other. When so engaged, the stepped surface 160 and the seal element 170 create an interference fit compressing the seal element and creating the seal. Additionally, the top surface 176 of the seal element 170 and the annular second shoulder 164 of the stepped surface 160 abut against each other thereby furthering the sealing effect.

To connect the seal element 170 to the rest of the filter element 112, the filter element also includes an end cap 180. The end cap 180 is a rigid, ring-like structure that, in the preferred embodiment illustrated in FIGS. 1 and 3, extends annularly about the axis line 102. The illustrated end cap 180 has an L-shaped cross-section including a first leg 182 oriented parallel to the axis line and a second leg 184 extending generally perpendicularly from the first leg radially inward toward the axis line. The end cap 180 engages a corner-like rim 188 of the filter media 130 formed by the intersection of the downstream face 134 and the cylindrical sidewall 138. When so engaged, the first leg 182 extends as an annular skirt about the filter media 130 while the second leg 184 is partially offset from the downstream face 134. The seal element 170 is attached to and projects in the axial direction from the second leg 184. The axial offset between the seal element 170 and the downstream face 134 of the filter media 130 functions as a stopping mechanism that axially positions the filter media within the filter housing 110. The end cap 180 and seal element 170 also helps prevent denting or damaging of the filter media 130 proximate the downstream face 134 during insertion of the filter element 112 into the filter housing 110. Additionally, the annular skirt-like structure provided by the first leg 182 of the end cap 180 helps hold the layers of the filter media 130 together.

In addition to the end cap 180, referring to FIG. 2, the filter element 112 may also include a grill plate 190. The grill plate 190 is a rigid, planar structure that, when assembled to the filter element 112, lies across the downstream face 134 and is retained thereto by the end cap 180. Axial forces from the fluid flowing through the filter media 130 are transferred by the grill plate 190 to the end cap 180 and are thereby directed to the filter housing 110. The grill plate 190 also prevents the radially inner core of the filter media 130 from being axially displaced due to the same forces. To allow fluids exiting the downstream face 134 to pass through the grill plate 190, a plurality of slots 192 are disposed therein. In the embodiment illustrated in FIG. 2, the grill plate 190 is a separate circular plate that can be received within the end cap 180 and abut against the radially inward directed second leg 184, though, in other embodiments the grill cap may be formed integrally with the end cap or formed otherwise. Both the end cap and the grill plate can be made from any suitable material including, for example, molded thermoplastic.

Referring to FIG. 3, to support the seal element 170 against the stepped surface 160 and prevent distortion of the compressible seal material, in one aspect of the invention the filter element 110 includes a ring-like support member 200 extending about the axis line 102. The support member 200 can be made from a rigid material, such as thermoplastic or metal, and is separate or distinct from the end cap 180 that connects the seal element 170 to the rest of the filter element 112. In the illustrated embodiment, the support member 200 is an annular band with a flat, rectangular cross-section that extends about and is generally parallel to the axis line 102. Furthermore, in the embodiment illustrated in FIG. 3, the support member 200 abuts against and extends axially from the second leg 184 of the end cap 180, but in other embodiments can be spaced-apart from the second leg. The seal element 170 can be formed about the support member 200 so that the support member is located between the radially outward directed sealing surface 172 and the radially inward directed inner surface 174. The top surface 176 of the seal element 170 extends across the support member 200 to maintain the integrity of the seal element. As will be appreciated by those of skill in the art, this construction can be accomplished where the seal element is made from a moldable material.

To mechanically attach the seal element 170 to the end cap 180, as illustrated in FIG. 4, or in other embodiments to the support member 200, projecting forks 202 can be formed as part of the end cap or support member. As illustrated, each fork 202 includes a stem 206 projecting perpendicularly from a surface 204 of the end cap 180 and crescent shaped furculum 208 formed at the tip of the stem which are generally parallel to and spaced-apart from the surface. Accordingly, when the seal element 170 is molded about the support member 200, the seal material fills around the furculum 208 and stem 206 and thus the forks 202 hold the seal element fast to the surface 204.

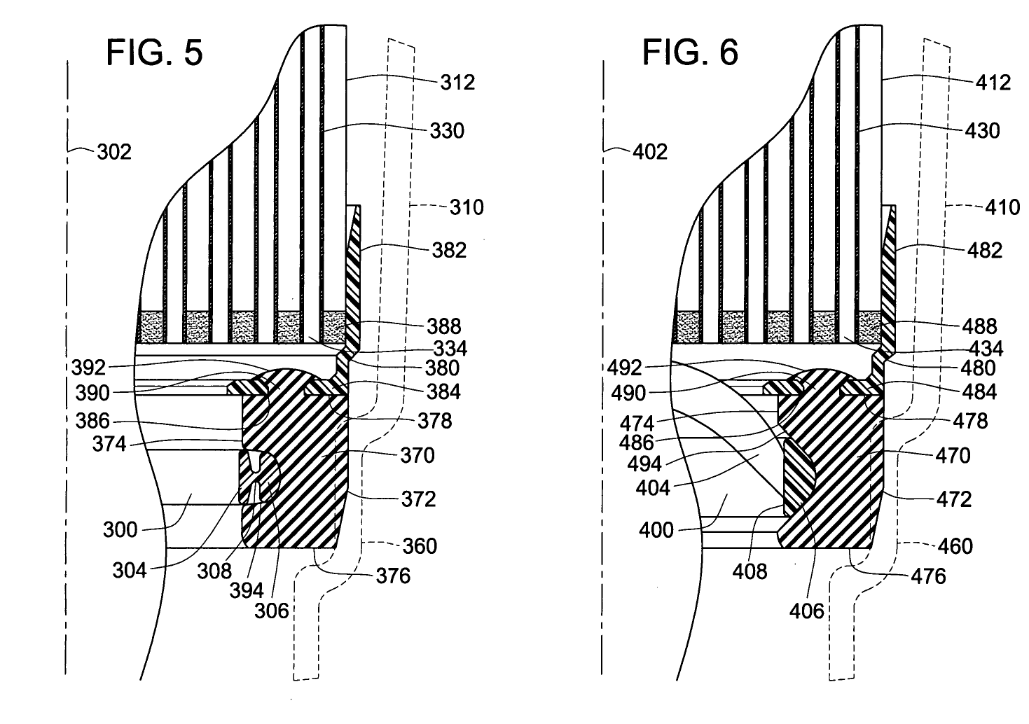

Referring to FIG. 5, there is illustrated an embodiment of the invention in which the support member 300 abuts against the seal element 370, as opposed to the support member being molded within the seal element. As described above, the compressible seal element 370 extends about an axis line 302 and has a generally rectangular cross-section including a radially outward directed sealing surface 372, a spaced-apart radially inward directed inner surface 374, and generally parallel, spaced-apart top and bottom surfaces 376, 378. To connect the seal element 370 to the rest of the filter element 312, the filter element also includes a ring-like end cap 380. The illustrated end cap 380 is made from a rigid material, such as molded thermoplastic, and extends annularly about the axis line 302. The end cap 380 has a first leg 382 arranged parallel to the axis line 302 which engages a rim-like corner 388 of the filter media 330 and a second leg 384 extending generally perpendicularly from the first leg radially toward the axis line and offset from the downstream face 334. The bottom surface 378 of the seal element 370 abuts against the second leg 384 with the rest of the seal element projecting axially in the downstream direction.

To mechanically attach the seal element 370 to the end cap 380, an aperture 386 is perpendicularly disposed through the second leg 384. The seal element 370 includes a neck portion 390 protruding axially from the bottom surface 378 that is received through the aperture 386. A flared head portion 392 is attached to the neck portion 390. Hence, the second leg 384 of the end cap 380 is clamped between the head portion 392 and the bottom surface 378 of the seal element 370. As will be appreciated by those of skill in the art, the described mechanical attachment can be readily produced by molding the seal element material to a pre-formed end cap.

To supportingly engage the seal element 370 with the support member 300, the support member is formed as a ring-like structure extending about the axis line 302 and that adjacently abuts the inner wall 374 of the seal element. By abutting the ring-like support member 300 against the inner wall 374, the seal element 370 is supported against the stepped surface 360 of the filter housing 310 thereby maintaining a consistent seal between the filter element 312 and the filter housing. The cross-section of the illustrated support member 300 has a general mushroom shape including a wider, radially inward base portion 304 and a rounded, radially outward dome portion 306 that are interconnected by a narrow intermediate portion 308. To maintain engagement between the seal element 370 and the support member 300, the seal element defines a recessed groove 394 annularly disposed into the inner wall 374. The outward dome portion 306 of the support member 300 can be received into the groove 394 such that fluid flowing through the filter assembly will not dislodge the support member.

Referring to FIG. 6, there is illustrated another embodiment of the invention wherein the support member 400 includes a strengthening rib 404 (that connects to another spaced apart portion of the support member 400) to improve the support member's support of the compressible seal element 470. The ring-like seal element 470 extends about an axis line 402 and has a generally rectangular cross-section including an radially outward directed sealing surface 472, a spaced-apart radially inward directed inner surface 474, and generally parallel, spaced-apart top and bottom surfaces 476, 478. To connect the seal element 470 to the rest of the filter element 412, the filter element also includes a ring-like end cap 480 made from a rigid material that extends about the axis line 402. The illustrated end cap 480 has a first leg 482 arranged parallel to the axis line 402 which engages a rim-like corner 488 of the filter media 430 and a second leg 484 extending generally perpendicularly from the first leg radially toward the axis line and offset from the downstream face 434. The bottom surface 478 of the seal element 470 abuts against the second leg 484 with the rest of the seal element projecting axially in the downstream direction.

To mechanically attach the seal element 470 to the end cap 480, an aperture 486 is perpendicularly disposed through the second leg 484 of the end cap. The seal element 470 includes a neck portion 490 and a flared head portion 492 protruding axially from the bottom surface 378 through the aperture 486 to clamp about the second leg 484.

To supportingly engage the seal element 470 with the support member 400, the support member is a ring-like structure extending about the axis line 402 and adjacently abuts the inner wall 474 of the seal element. By abutting the ring-like support member 400 against the inner wall 474, the seal element 470 is supported against the stepped surface 460 of the filter housing 410 thereby maintaining a consistent seal between the filter element 412 and the filter housing. In the illustrated embodiment, the support member 400 has a D-shaped cross-section that includes a curved front surface 406 and a flat back surface 408. To maintain engagement between the seal element 470 and the support member 400, the seal element defines a recessed groove 494 annularly disposed into the inner surface 474. The curved front surface 406 of the support member 400 can be received into the groove 494 such that fluid flowing through the filter assembly will not dislodge the support member.

The strengthening rib 404 is integral with and extends between the ring-like support member 400. As will be appreciated, in those embodiments in which the support member 400 is circular, the rib 404 can extend across the diameter of the circular support member or can extend as a smaller cord. Additionally, multiple strengthening ribs arranged in a side-by-side manner can be provided extending between the support member. Furthermore, in the illustrated embodiment, the rib 404 depends axially toward the downstream face 434 of the filter media 430. Hence, in addition to strengthening the support member 400, the depending rib 404 also prevents axial displacement of the filter media due to forces from the flowing fluids. The support member and strengthening rib can be formed from any suitable rigid material such as, for example, molded thermoplastic.

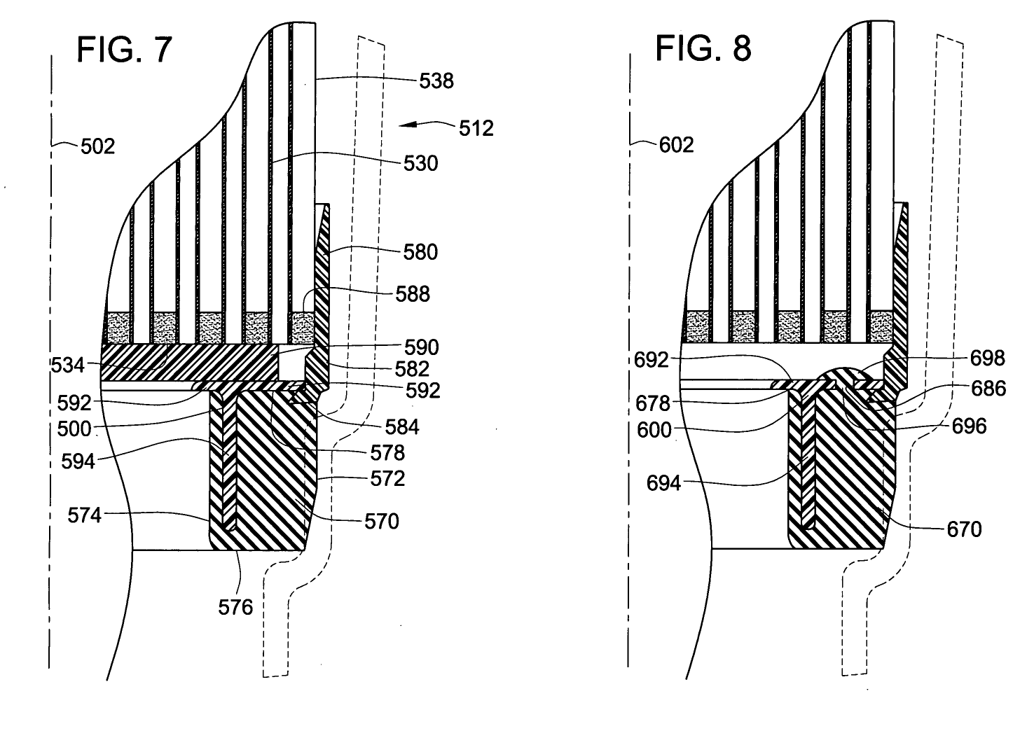

Referring to FIG. 7, there is illustrated another embodiment of the invention wherein the support member 500 is, in addition to supporting the seal element 570, connected to a grill plate 590 that is generally of the above-described construction. The seal element 570 extends about an axis line 502 and has a generally rectangular cross-section including a radially outward directed sealing surface 572, a spaced-apart radially inward directed inner surface 574, and generally parallel, spaced-apart top and bottom surfaces 576, 578. The illustrated support member 500 also extends about the axis line 502 and has a T-shaped cross-section including an annular first leg 592 axially spaced-apart from and parallel to the downstream face 534 of the filter media 530 and a second leg 594 extending perpendicularly from the first leg in the axial direction. The seal element 570 is formed about the second leg 594 such that the bottom surface 578 abuts the first leg 592 and the seal material generally surrounds the second leg. As will be appreciated, the seal element 570 is thereby secured to the support member 500. In various embodiments, the second leg 594 can be formed as a continuous ring-like structure extending around the axis line 502 or can be formed as a plurality of posts radially-spaced along and extending from the annular first leg 592. The grill plate 590 lies adjacent the downstream face 534 of the filter media 530 and is retained thereto by the first leg 592 of the support member 500.

To connect the seal element 570, support member 500 and grill plate 590 to the rest of the filter element 512, the filter element also includes an end cap 580. The end cap 580 is a rigid, ring-like structure that extends about the axis line 502. The end cap 580 engages a corner-like rim 588 of the filter media 530 formed by the intersection of the downstream face 534 and a sidewall 538. When so engaged, the end cap 580 includes a tip portion 582 extending beyond the downstream face 534 that is formed with a radially inward projecting hook 584. As illustrated in FIG. 7, the hook 584 extends around the first leg 592 of the support member 500 and hooks into the outward directed sealing surface 572 of the compressible seal element 570. Accordingly, the seal element 570, support member 500, and grill plate 590 are secured with respect to the filter media 530 and restrained against displacement due to fluid forces.

Referring to FIG. 8, in an embodiment similar in construction to that illustrated in FIG. 7, to mechanically attach the seal element 670 to the support member 600, an aperture 686 is perpendicularly disposed through a first leg 692 of the support member. The seal element 670 includes a neck portion 696 and a flared head portion 698 protruding axially from the bottom surface 678 of the seal element through the aperture 686 to clamp the first leg 692. Accordingly, the seal element 670 is secured in place with respect to the rest of the filter element by both being formed about the second leg 694 and by the mechanical attachment to the first leg 692.

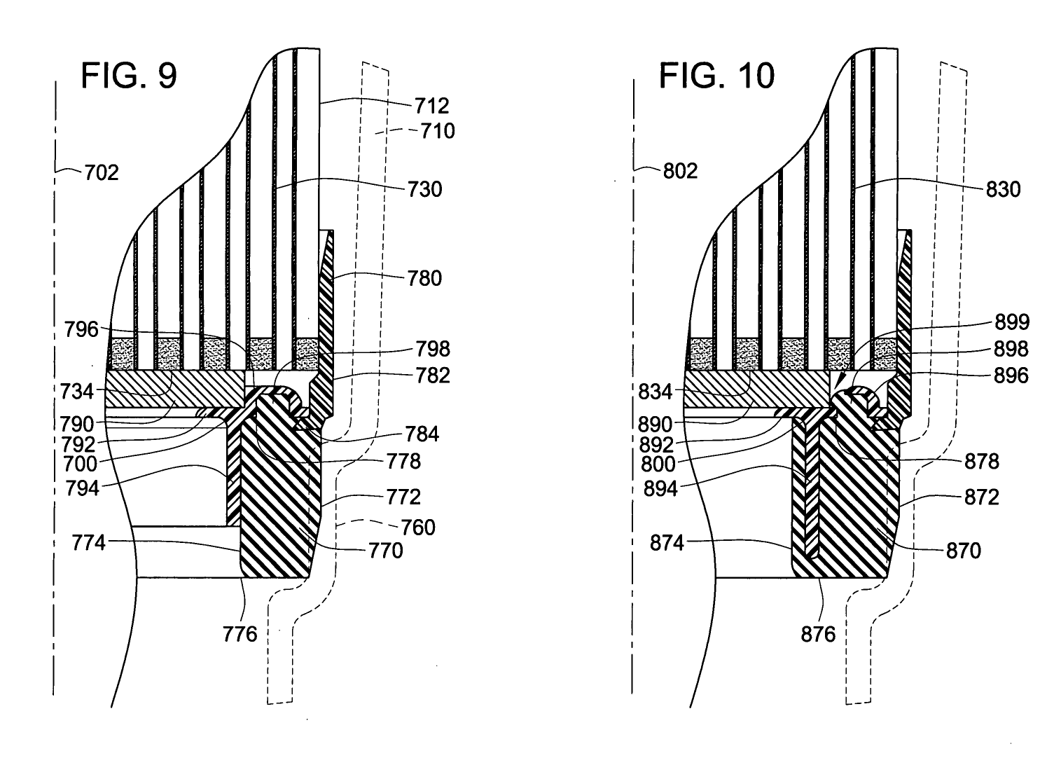

Referring to FIG. 9, there is illustrated an embodiment in which the support member 700 and the seal element 770 are mechanically attached together. The compressible seal element 770 extends about an axis line 702 and has a generally rectangular cross-section including a radially outward directed sealing surface 772, a spaced-apart radially inward directed inner surface 774, and generally parallel, spaced-apart top and bottom surfaces 776, 778. The ring-like support member 700 also extends about the axis line 702 and has a T-shaped cross-section including an annular first leg 792 axially spaced-apart from and parallel to the downstream face 734 of the filter media 730 and a second leg 794 extending perpendicularly from the first leg in the axial direction. The second leg 794 extends along the inner surface 774 of the seal element 770 while the first leg 792 abuts the bottom surface 778 to support the seal element against the stepped surface 760 of the filter housing 710. Also included is a grill plate 790 that lies adjacent the downstream face 734 of the filter media 730 and that is held in place by to the support member 700.

To connect the seal element 770 and support member 700 to the rest of the filter element 712, the filter element includes a ring-like end cap 780 engaged to the filter media 730 and which extends about axis line 702. The end cap 780 includes a tip portion 782 extending beyond the downstream face 734 that is formed with a radially inward projecting hook 784 that extends around the first leg 792 of the support member 700 and hooks into the outward directed sealing surface 772 of the compressible seal element 770.

To mechanically attach the support member 700 and seal element together 770, there is formed into the first leg 792 of the support member one or more hollow knobs 796 that are directed toward the downstream face 734 of the filter media 730. Furthermore, the seal element 770 includes at least one plug 798 projecting axially from the bottom surface 778 that corresponds in position to and can be received in a void defined by the hollow knob 796. As will be readily appreciated, receiving the plug 798 into the hollow knob 796 can be accomplished in various ways such as by molding the seal element 770 to the support member 700 or by pre-molding the seal element and attaching it to the support member. As will also be appreciated, where the support member 700 includes multiple hollow knobs 796 formed about the ring-like support member, the seal element 770 can include multiple plugs 798 each corresponding to a knob.

Referring to FIG. 10, there is illustrated another embodiment, similar in construction to that illustrated in FIG. 9, in which the compressible seal element 870 is both formed about and mechanically attached to the rigid support member 800. The seal element 870 extends about an axis line 802 and has a generally rectangular cross-section including a radially outward directed sealing surface 872, a spaced-apart radially inward directed inner surface 874, and generally parallel, spaced-apart top and bottom surfaces 876, 878. The illustrated support member 800 also extends about the axis line 802 and has a T-shaped cross-section including an annular first leg 892 axially spaced-apart from and parallel to a downstream face 834 of the filter media 830 and a second leg 894 extending perpendicularly from the first leg in the axial direction. The seal element 870 is formed about the support member 800 such that bottom surface 878 abuts the first leg 892 and the seal material generally surrounds the second leg 894. Additionally, a grill plate 890 can be located between the second leg 892 and the downstream face 834 of the filter media 830.

To provide the mechanical attachment, there is formed into the first leg 892 of the support member 800 one or more hollow knobs 896 that are directed toward the downstream face 834 of filter media 830. The seal element 870 includes at least one plug 898 projecting axially from the bottom surface 878 that corresponds in position to and can be received in a void defined by the hollow knob 896 thereby further attaching the seal element to the support member 800. In the illustrated embodiment, there is disposed through the knob 896 a slit 899 that allows the seal material from the plug 898 to extrude partially about the knob and the first leg 892 further improving the mechanical attachment.

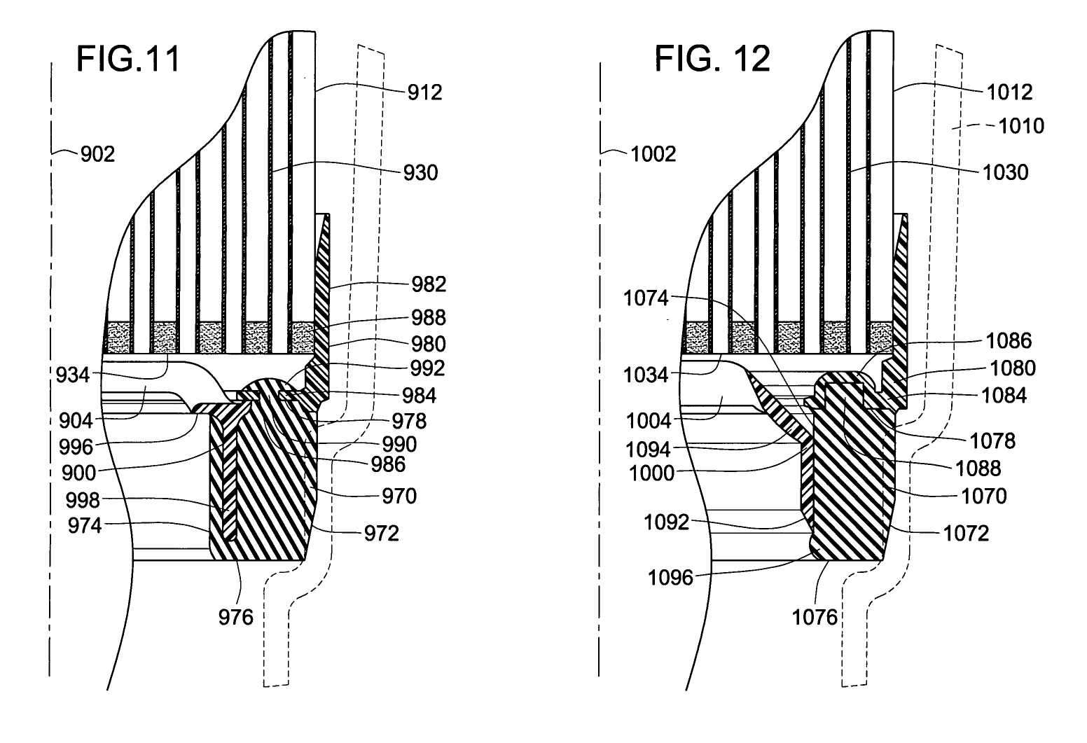

Referring to FIG. 11, there is illustrated another embodiment wherein the separate support member 900 includes a strengthening rib 904 to improve the support member's support of the seal element 970. The compressible seal element 970 extends about an axis line 902 and has a generally rectangular cross-section including a radially outward directed sealing surface 972, a spaced-apart radially inward directed inner surface 974, and generally parallel, spaced-apart top and bottom surfaces 976, 978. To attach the seal element 970 to the rest of the filter element 912, the filter element also includes an end cap 980 that extends about the axis line 902. The illustrated end cap 980 has an L-shaped cross-section including a first leg 982 oriented parallel to the axis line 902 and a second leg 984 extending perpendicularly from the first leg radially inward toward the axis line. The end cap 980 engages a corner-like rim 988 of the filter media 930. The bottom surface 978 of the seal element 970 abuts against the second leg 984 with the rest of the seal element projecting axially in the downstream direction.

To mechanically attach the seal element 970 to the end cap 980, an aperture 986 is perpendicularly disposed through the second leg 984 of the end cap. The seal element 970 includes a neck portion 990 protruding axially from the bottom surface 978 through the aperture 986 and a flared head portion 992 that clamps about the second leg 984.

To supportingly engage the seal element 970 with the support member 900, the support member is a ring-like structure extending about the axis line 902. In the illustrated embodiment, the cross-section of the support member is generally T-shaped including an annular first leg 996 axially spaced-apart from and parallel to the downstream face 934 of the filter media 930 and a second leg 998 extending perpendicularly from the first leg in the axial direction. The seal element 970 is formed about the second leg 998 such that the bottom surface 978 abuts against the first leg 996 and the seal material generally surrounds the second leg.

The strengthening rib 904 is joined to and extends from the first leg 996 across the ring-like support member 900. As will be appreciated, in those embodiments in which the support member 900 is circular, the rib 904 can extend across the diameter of the circular support member or can extend as a smaller cord. Furthermore, in the illustrated embodiment, the rib 904 depends axially toward the downstream face 934 of the filter media 930, thereby preventing axial displacement of the filter media.

There is illustrated in FIG. 12 another embodiment of the filter element 1012 wherein the compressible seal element 1070 is mechanically attached to the rigid end cap 1080. The seal element 1070 extends about the axis line 1002 and has a generally rectangular cross-section including a radially outward directed sealing surface 1072, a spaced-apart radially inward directed inner surface 1074, and generally parallel, spaced-apart top and bottom surfaces 1076, 1078. The illustrated end cap 1080 also extends about the axis line 1002 and has a general L-shaped cross-section including a first leg 1082 parallel to the axis line for engaging the filter media 1030 and a second leg 1084 extending perpendicularly from the first leg and offset from the downstream face 1034 of the filter media 1030. To mechanically attach the seal element 1070 and the end cap 1080, the end cap includes at least one hollow knob 1086 that can receive a plug 1088 projecting from the bottom surface 1078 of the seal element.

To support the seal element 1070 against the filter housing 1010, a separate ring-like support member 1000 extends about the axis line 1002 and runs along the inner surface 1074 of the seal element. The support member 1000 includes a tubular portion 1092 which is parallel to the axis line 1002 and a conical portion 1094 that projects radially inward from the tubular portion. It will be appreciated that the conical portion 1094 facilitates assembling the seal element 1070 and support member 1000 by enabling axially inserting the support member into the annular seal element. Preferably, in the illustrated embodiment, the seal element 1070 includes a backdraft 1096 proximate the top surface 1076 that extends partly over the tubular portion 1092 when the support member is correctly inserted. To strengthen the support member 1000, a strengthening rib 1004 can extend from the conical portion 1094 across the ring-like support member. As described above, when the support member 1000 is circular, the strengthening rib 1004 can extend as a diameter or a chord, and that multiple strengthening ribs can be provided in a side-by-side arrangement.

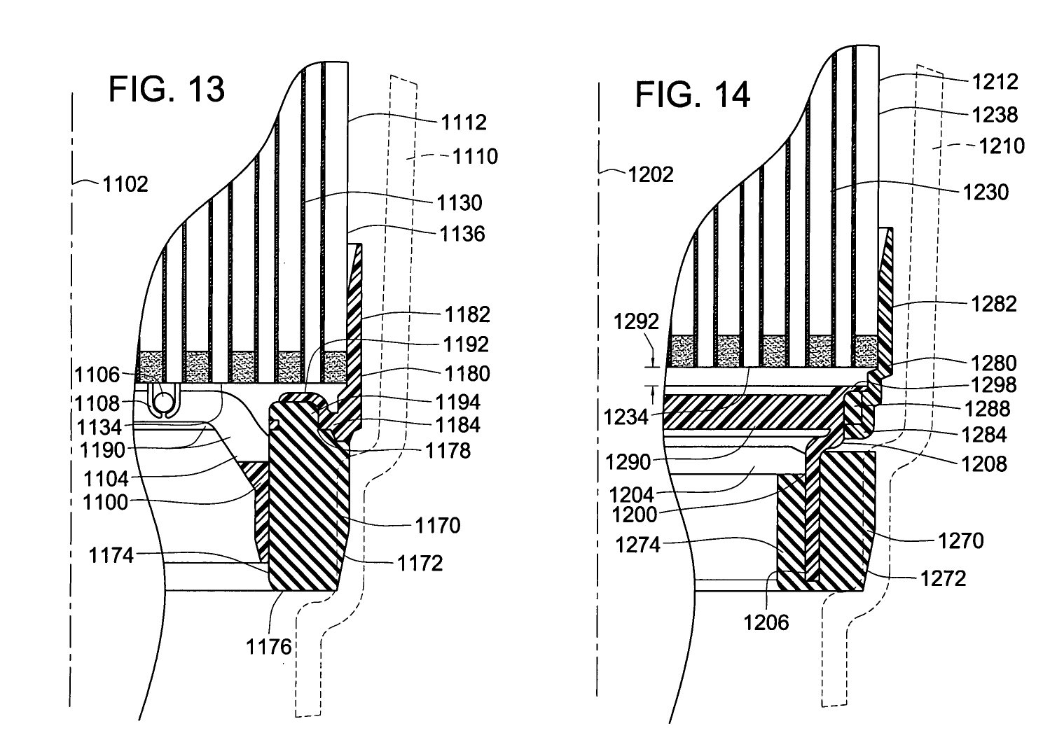

Referring to FIG. 13, there is illustrated another embodiment in which the strengthening rib 1104 of the support member 1100 can engage the grill plate 1190. In addition to the support member 1100 and the grill plate 1190, the embodiment of FIG. 11 includes the ring-like seal element 1170 that extends about the axis line 1102. The seal element 1170 includes a radially outward directed sealing surface 1172, a spaced-apart, radially inward directed inner surface 1174, and generally parallel, spaced-apart top and bottom surfaces 1176, 1178. To connect the seal element 1170 to the rest of the filter element 1112, the filter element also includes an end cap 1180 that engages the filter media 1130. The end cap 1180 has first, skirt-like leg 1182 that is arranged parallel to the axis line 1102 which engages the filter media 1130 and a second leg 1184 extending perpendicularly from the first leg radially toward the axis line and offset from the downstream face 1134. To mechanically attach the seal element 1170 and the end cap 1180, a hollow knob 1192 is formed into the second leg 1184 that can receive a plug 1194 projecting from bottom surface 1178.

The ring-like support member 1100 extends about the axis line 1102 and adjacently abuts against the inner surface 1174 of the seal element 1170 to support the seal element against the filter housing 1110. The strengthening rib 1104 is integral with and extends from the support member 1100 generally adjacent to the downstream face 1134 of the filter media 1130. Also located adjacent the downstream face 1134 is the grill plate 1190, which can be formed integrally with the end cap 1180 or formed separately. To engage the support member 1100 and grill plate 1190, posts 1106 extend from the strengthening rib 1104 parallel to the downstream face 1134 that can be received between pairs of fingers 1108 that project from the grill plate. The posts 1106 can be received between the fingers 1108 in a snap-fit manner so that the grill plate 1190 holds the support member 1100 in place.

Referring to FIG. 14, there is illustrated another embodiment in which the grill plate 1290 can be formed integrally with one or more strengthening ribs 1204 of the support member 1200. The ring-like support member 1200 extends about the axis line 1202 and includes an axially parallel straight portion 1206 and a radially outward projecting stepped portion 1208. The strengthening ribs 1204 extend generally from the straight portion 1206 across the ring-like support member 1200. The grill plate 1290 can be suspended between multiple ribs 1204 that are aligned side-by-side across the downstream face 1234 of the filter media 1230. The ribs 1204 and grill plate 1290 can be adjacent to the downstream face 1234 or, as illustrated, can be spaced-apart by a slight gap indicated by arrows 1292. In addition to the integral grill plate 1290 and support member 1200, the embodiment of FIG. 12 includes a ring-like seal element 1270 that extends about the axis line 1202. The seal element 1270 is formed about the straight portion 1206 of the support member 1200 so that the support member is located between the radially outward directed sealing surface 1272 and the radially inward directed inner surface 1274 and thus supports the seal element against the filter housing 1210.

To connect the seal element 1270, separate support member 1200, and grill plate 1290 to the rest of the filter element 1212, the filter element includes an end cap 1280. The illustrated end cap 1280 includes a skirt-like first leg 1282 that extends about the sidewall 1238 of the filter media 1230 and beyond the downstream face 1234. Formed at the end of the first leg 1282 is a radially inward directed flange 1284 that extends beyond and overlaps a radially outward directed step 1298 projecting from the stepped portion 1208 of the support member 1200. By receiving the step 1298 between the overlapping flange 1284 and downstream face 1234 of the filter media 1230, the support member 1200, the seal element 1270, the strengthening rib 1204, and the grill plate 1290 are secured to the rest of the filter element 1212. A compressible, annular gasket 1288 is located between the flange 1284 and the step 1298 to allow for limited sliding movement in the axial direction between the end cap 1280 and support member 1200.

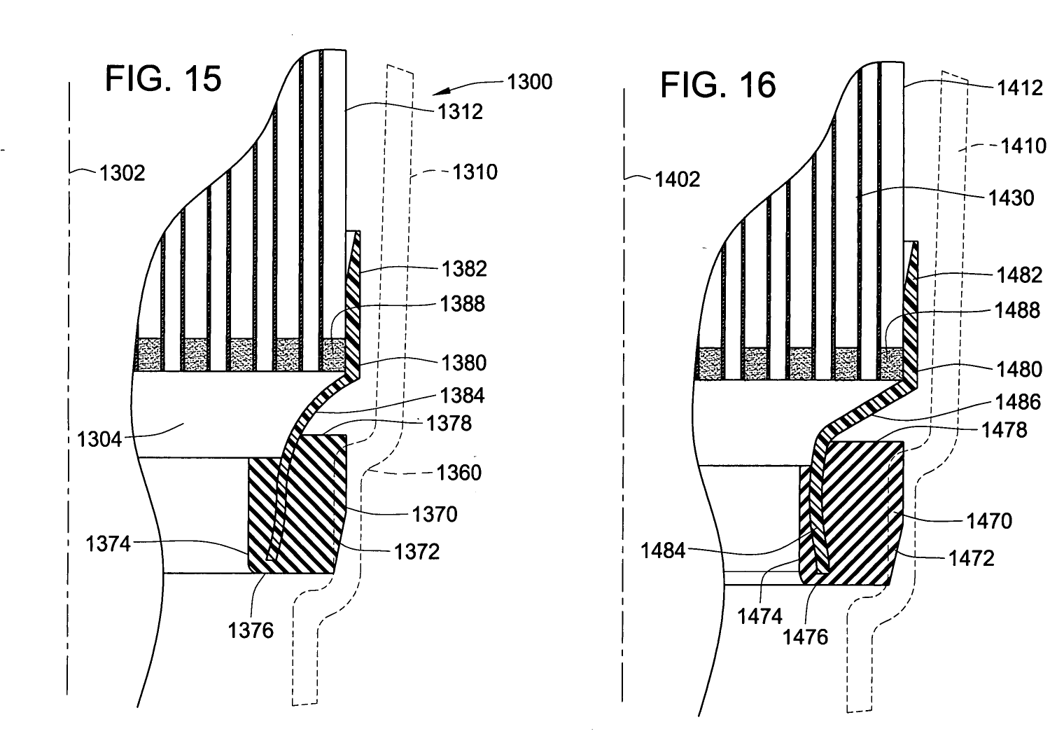

Referring to FIG. 15, there is illustrated another embodiment of a filter assembly 1300 in which, in another aspect of the invention, the compressible seal element 1370 is connected to the rest of the filter element 1312 by being formed directly onto a portion of the rigid end cap 1380. The ring-like seal element 1370 extends about the axis line 1302 and includes a radially outward directed sealing surface 1372, a spaced-apart, radially inward directed inner surface 1374, and generally parallel, spaced-apart top and bottom surfaces 1376, 1378. The ring-like end cap 1380 also extends about the axis line 1302 and includes a skirt-like first leg 1382 that engages the corner-like rim 1388 of the filter media 1330. The end cap 1380 also includes a second leg 1384 that extends beyond the downstream face 1334 of the filter media 1330. The cross-section of the second leg 1384, however, is formed with a wave-like shape that gradually curves radially inward as the second leg extends in the axial direction. Hence, at least substantial portions of the second leg 1380 are not parallel with the axis line 1302. As will be appreciated, in those embodiments in which the filter components are circular, the second leg 1384 will produce an annular shell of varying diameters as the second leg extends in the axial direction.

To attach the seal element 1370 to the second leg 1384, the seal material is molded about the second leg such that the second leg is located between the radially outward directed sealing surface 1372 and the radially inward directed inner surface 1374. The seal element 1370 is therefore positioned against the stepped surface 1360 of the filter housing 1310. Because of the wave-like shape of the second leg 1384, the molded seal element 1370 is sufficiently restrained against detaching from the end cap 1380. To improve the strength of the end cap 1380, a strengthening rib 1304 can be included that extends across the second leg 1384 of the ring-like end cap. Preferably, the embodiment illustrated in FIG. 15 does not include a separate support member for supporting the seal element. However, it should be recognized that in different embodiments a separate support member be can utilized as described above.

Referring to FIG. 16, there is illustrated another embodiment in which the compressible seal element 1470 is connected to the rest of the filter element 1412 by being formed directly onto a portion of the rigid end cap 1480. The ring-like seal element 1470 extends about the axis line 1402 and includes a radially outward directed sealing surface 1472, a spaced-apart, radially inward directed inner surface 1474, and generally parallel, spaced-apart top and bottom surfaces 1476, 1478. The ring-like end cap 1480 also extends about the axis line 1402 and includes a skirt-like first leg 1482 that engages the corner-like rim 1488 of the filter media 1430 and a second leg 1484 to which the seal element 1470 is attached. A third leg 1486 interconnects the first and second legs 1482, 1484 by extending at an angle such that the second leg is situated radially inward of the first leg.

The second leg 1484 is generally curved so that it arcs away from the axis line 1402 and, hence, at least substantial portions of the second leg are not parallel with the axis line. Accordingly, where the components of the filter assembly are generally circular, the second leg 1484 provides a generally hyperbolic-shaped shell about the axis line 1402. To attach the seal element 1470 to the second leg 1484, the seal material is molded about the second leg such that the second leg is located between the radially outward directed sealing surface 1472 and the radially inward directed inner surface 1474. Because of the hyperbolic shape of the second leg 1484, the molded seal element 1470 is sufficiently restrained against detaching from the end cap 1480. Additionally, while the embodiment illustrated in FIG. 16 preferably does not include a separate support member for supporting the seal element against the filter housing, it should be appreciated that in other embodiments, such a support member can be included.

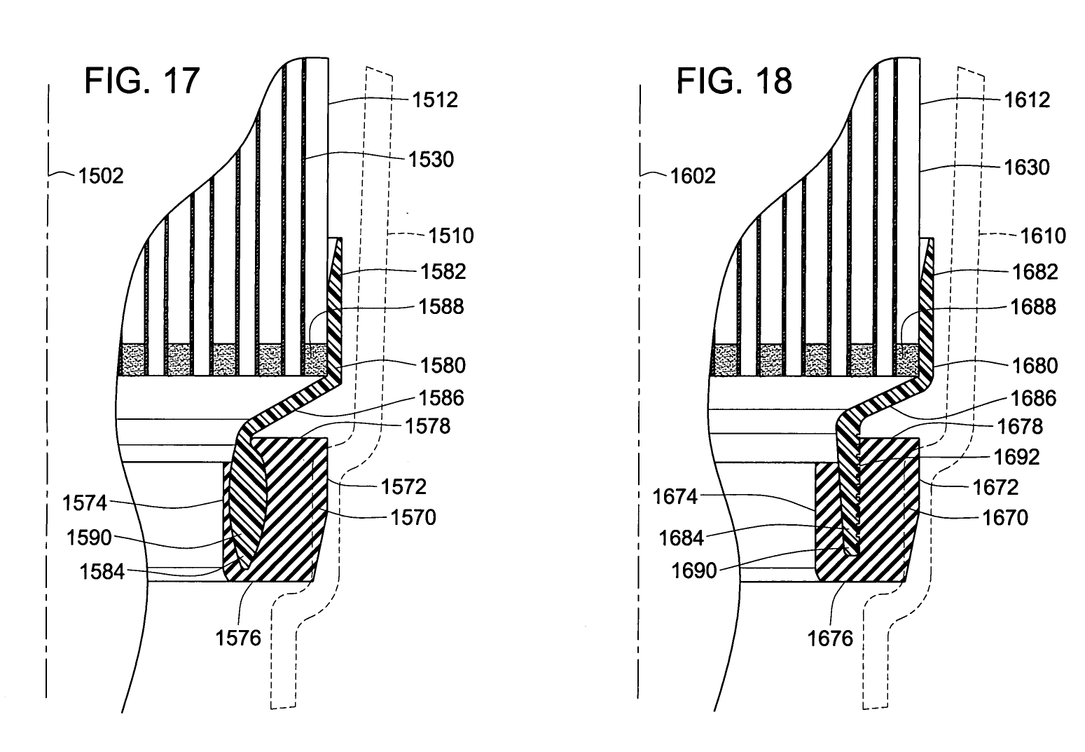

Referring to FIG. 17, there is illustrated another embodiment in which the compressible seal element 1570 is connected to the rest of the filter element 1512 by being formed directly onto a portion of the rigid end cap 1580. The ring-like seal element 1570 extends about the axis line 1502 and includes a radially outward directed sealing surface 1572, a spaced-apart, radially inward directed inner surface 1574, and generally parallel, spaced-apart top and bottom surfaces 1576, 1578. The ring-like end cap 1580 also extends about the axis line 1502 and includes a skirt-like first leg 1582 that engages the corner-like rim 1588 of the filter media 1530 and a second leg 1584 to which the seal element 1570 is attached. A third leg 1586 interconnects the first and second legs 1582, 1584 by extending at an angle such that the second leg is situated radially inward of the first leg.

Unlike the first and third legs 1582, 1586 that are formed with a generally consistent thickness, the second leg 1584 is formed with an enlarged lobe portion 1590. Hence, a least a substantial portion of the second leg 1584 is not parallel with the axis line 1502. The lobe portion 1590 substantially enlarges the end cap 1580 and provides an object around which the seal material can be molded. Accordingly, with the seal element 1570 attached to the end cap 1580, the lobe portion 1590 is generally located between the radially outward directed sealing surface 1572 and the radially inward directed inner surface 1574. Because of the enlarged lobe portion 1590, the molded seal element 1570 is sufficiently restrained against detaching from the end cap 1580. Additionally, while the embodiment illustrated in FIG. 17 preferably does not include a separate support member for supporting the seal element against the filter housing, it should be appreciated that in other embodiments, such a support member can be included.

Referring to FIG. 18, there is illustrated another embodiment in which the compressible seal element 1670 is connected to the rest of the filter element 1612 by being formed directly onto a portion of the rigid end cap 1680. The ring-like seal element 1670 extends about the axis line 1602 and includes a radially outward directed sealing surface 1672, a spaced-apart, radially inward directed inner surface 1674, and generally parallel, spaced-apart top and bottom surfaces 1676, 1678. The ring-like end cap 1680 also extends about the axis line 1602 and includes a skirt-like first leg 1682 that engages the corner-like rim 1688 of the filter media 1630 and a second leg 1684 to which the seal element 1670 is attached. A third leg 1686 interconnects the first and second legs 1682, 1684 by extending at an angle such that the second leg is situated radially inward of the first leg.

The second leg 1684, which also extends about the axis line 1602, is considerably thicker where it joins the third leg 1686 but tapers in the axially direction to a thinner tip portion 1690. Hence, at least a substantial portion of the second leg 1684 is not parallel to the axis line 1602. Preferably, the third leg 1686 tapers generally at an angle of about 5 degrees from the axis line 1602. Furthermore, at least one surface of the second leg 1684 can be serrated or grooved to provide a plurality of notches 1692. To attach the seal element 1670 to the second leg 1684, the seal material is molded about the second leg such that the second leg is located between the radially outward directed sealing surface 1672 and the radially inward directed inner surface 1674. Because of the notches 1692 provided in the second leg 1684, the molded seal element 1670 is sufficiently restrained against detaching from the end cap 1680. Additionally, while the embodiment illustrated in FIG. 18 preferably does not include a separate support member for supporting the seal element against the filter housing, it should be appreciated that in other embodiments, such a support member can be included.

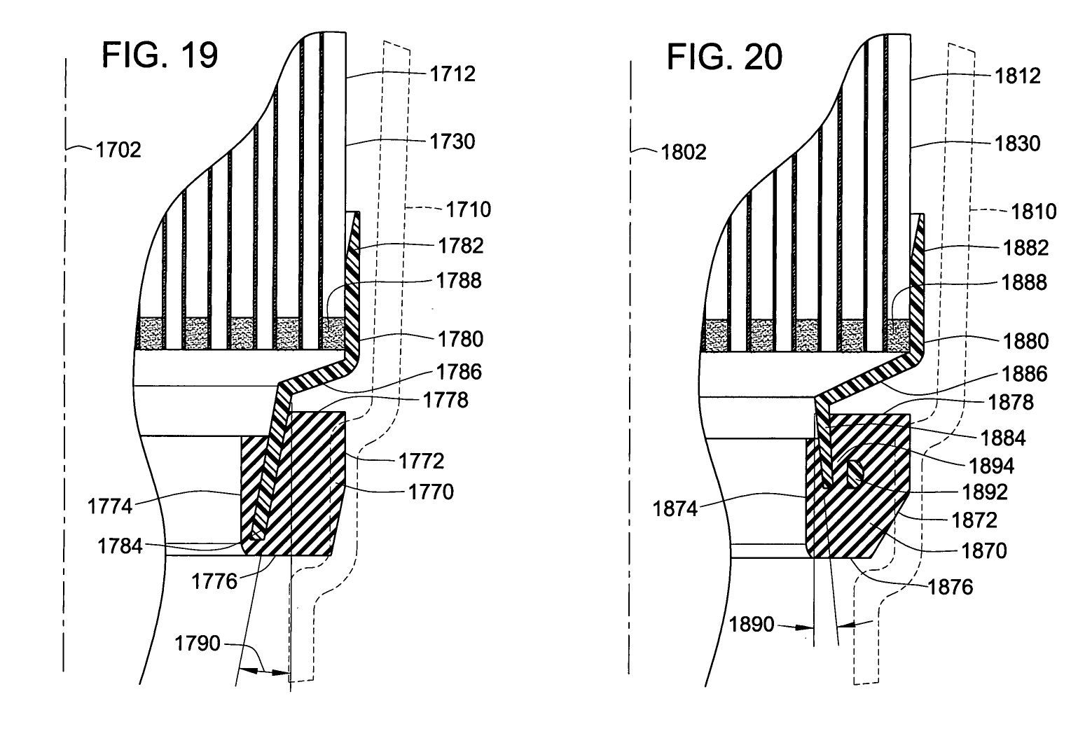

Referring to FIG. 19, there is illustrated another embodiment in which the compressible seal element 1770 is connected to the rest of the filter element 1712 by being formed directly onto a portion of the rigid end cap 1780. The ring-like seal element 1770 extends about the axis line 1702 and includes a radially outward directed sealing surface 1772, a spaced-apart, radially inward directed inner surface 1774, and generally parallel, spaced-apart top and bottom surfaces 1776, 1778. The ring-like end cap 1780 also extends about the axis line 1702 and includes a skirt-like first leg 1782 that engages the corner-like rim 1788 of the filter media 1730 and a second leg 1784 to which the seal element 1770 is attached. A third leg 1786 interconnects the first and second legs 1782, 1784 by extending at an angle such that the second leg is situated radially inward of the first leg.

The second leg 1784 extends from the third leg 1786 at a radially inward angle with respect to the axis line 1702 such that the second leg is not parallel with the axis line. Preferably, the angle, designated as 1790 in FIG. 19, is approximately 10 degrees. Accordingly, in the embodiments where the filter assembly components are circular, it will be appreciated that the second leg 1784 generally forms a cone as it extends about the axis line 1702. To attach the seal element 1770 to the second leg 1784, the seal material is molded about the second leg such that the second leg is located between the radially outward directed sealing surface 1772 and the radially inward directed inner surface 1774. Because of the angle 1790 with which the second leg 1784 is oriented with respect to the axis line 1702, the molded seal element 1770 is sufficiently restrained against detaching from the end cap 1780. Additionally, while the embodiment illustrated in FIG. 19 preferably does not include a separate support member for supporting the seal element against the filter housing, it should be appreciated that in other embodiments, such a support member can be included.

Referring to FIG. 20, there is illustrated another embodiment in which the compressible seal element 1870 is connected to the rest of the filter element 1812 by being formed directly onto a portion of the rigid end cap 1880. The ring-like seal element 1870 extends about the axis line 1802 and includes a radially outward directed sealing surface 1872, a spaced-apart, radially inward directed inner surface 1874, and generally parallel, spaced-apart top and bottom surfaces 1876, 1878. The ring-like end cap 1880 also extends about the axis line 1802 and includes a skirt-like first leg 1882 that engages the corner-like rim 1888 of the filter media 1830 and a second leg 1884 to which the seal element 1870 is attached. A third leg 1886 interconnects the first and second legs 1882, 1884 by extending at an angle such that the second leg is situated radially inward of the first leg.

The second leg 1884 extends from the third leg 1886 at a radially outward angle with respect to the axis line 1802 such that the second leg is not parallel with the axis line. Preferably, the angle, designated by 1890 in FIG. 20, is approximately 5 degrees. Additionally, the second leg 1884 has formed at its distal tip a radially outward directed flange 1892. Accordingly, in the embodiments where the filter assembly components are circular, it will be appreciated that, as the end cap 1880 extends about the axis line 1802, the flange 1892 forms a flat annular surface extending from the shell defined by the second leg 1884. To attach the seal element 1870 to the second leg 1884, the seal material is molded about the second leg and the flange 1892 such that the second leg is located between the radially outward directed sealing surface 1872 and the radially inward directed inner surface 1874. Furthermore, there can be disposed through the flange 1892 a plurality of axially oriented holes 1894 that can receive seal material during molding. Because of the flange 1892 and seal material receiving holes 1894, the molded seal element 1870 is sufficiently restrained against detaching from the end cap 1880. Additionally, while the embodiment illustrated in FIG. 20 preferably does not include a separate support member for supporting the seal element against the filter housing, it should be appreciated that in other embodiments, such a support member can be included.

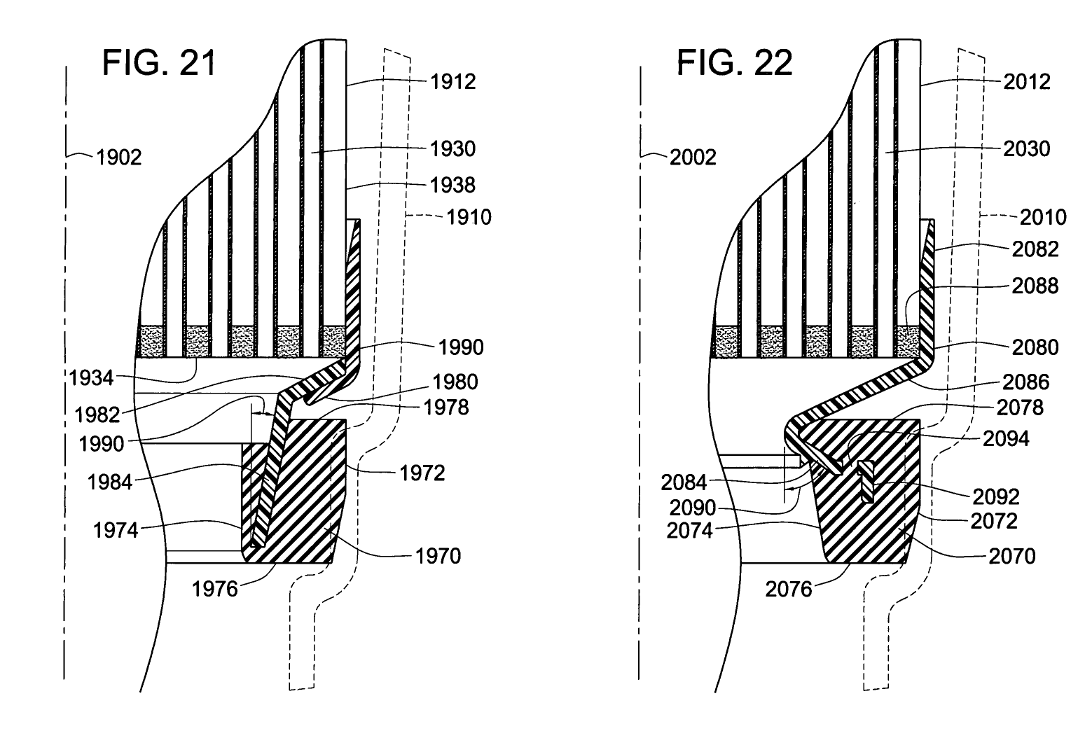

Referring to FIG. 21, there is illustrated another embodiment in which the compressible seal element 1970 is formed onto the rigid end cap 1980 which in turn is taped to the rest of the filter element 1912. The ring-like seal element 1970 extends about the axis line 1902 and includes a radially outward directed sealing surface 1972, a spaced-apart, radially inward directed inner surface 1974, and generally parallel, spaced-apart top and bottom surfaces 1976, 1978. The end cap 1980, which also extends about the axis line 1902 in a ring-like fashion, includes a first leg 1982 and a second leg 1984 joined together at an angle. Accordingly in those embodiments wherein the filter elements are circular, the end cap 1980 forms a shell appearing as two abutting cones of differing angles extending about the axis line 1902.

The end cap 1980 is oriented such that the first leg 1982 abuts against the downstream face 1934 of the filter media 1930 and the second leg 1984 is axially directed toward the outlet of the filter housing 1910. Preferably, the second leg 1984 is oriented to form an angle 1990 with respect to the axis line 1902 of approximately 10 degrees. To attach the end cap 1980 to the rest of the filter element 1912, a length of tape 1990 is fastened about the first leg 1982 and the sidewall 1938 of the filter media 1930.

Referring to FIG. 22, there is illustrated another embodiment in which the compressible seal element 2070 is formed onto a rigid end cap 2080 that in turn is attached to the rest of the filter assembly 2012. The ring-like seal element 2070 extends about the axis line 2002 and includes a radially outward directed sealing surface 2072, a spaced-apart, radially inward directed inner surface 2074, and generally parallel, spaced-apart top and bottom surfaces 2076, 2078. The ring-like end cap 2080 also extends about the axis line 2002 and includes a skirt-like first leg 2082 that engages the corner-like rim 2088 of the filter media 2030 and a second leg 2084 to which the seal element 2070 is attached. A third leg 2086 interconnects the first and second legs 2082, 2084 and extends from the first leg at a radially inward directed angle. The second leg 2084, in turn, extends from the third leg 2086 at a radially outward directed angle such that the second and third legs diverge from their common joining point. Preferably, the second leg 2084 extends so as to form an angle 2090 of approximately 60 degrees with respect to the axis line 2002. Accordingly, where the components of the filter element are circular, the second and third legs 2084, 2086 form a shell appearing as two cones abutted together at their narrower ends as the end cap 2080 extends about the axis line 2002.

To attach the seal element 2070 to the second leg 2084, the seal material is molded about the second leg such that the second leg extends into the inner surface 2074 and partway across the seal element to the outer sealing surface 2072. Some of the seal material proximate the bottom surface 2078 can collect between the angularly interconnected second and third legs 2084, 2086. Formed at the distal tip of the second leg 2084 is an axially extending flange 2092 while formed into the second leg are a plurality of axially aligned holes 2094. It will be appreciated that the flange 2092 can have the same material thickness as the second leg 2084, a reduced thickness, or an increased thickness. Because of the flange 2092 and seal material receiving holes 2094, the molded seal element 2070 is sufficiently restrained against detaching from the end cap 2080. Additionally, while the embodiment illustrated in FIG. 22 preferably does not include a separate support member for supporting the seal element against the filter housing, it should be appreciated that in other embodiments, such a support member can be included.

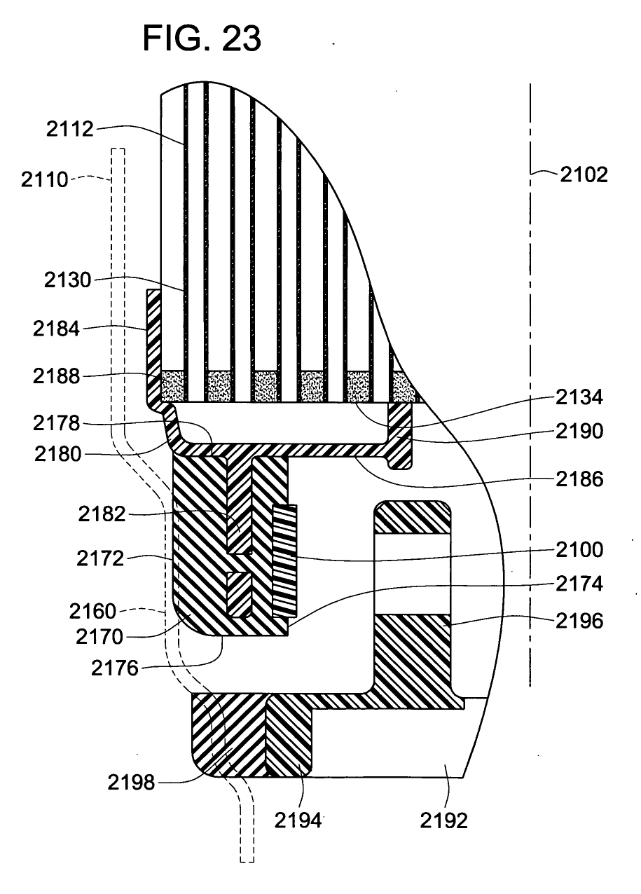

In accordance with another aspect of the invention, the seal element can be supported against the housing by a plurality of posts. Referring to FIG. 23, there is illustrated another embodiment wherein the seal element 2170 is connected to the rest of the filter element 2112 by a rigid end cap 2180 formed with a plurality of posts 2182. As described above, the ring-like seal element 2170 extends about the axis line 2102 and has a generally rectangular cross-section including a outward directed sealing surface 2172, a spaced-apart, radially inward directed inner surface 2174, and generally parallel, spaced-apart top and bottom surfaces 2176, 2178. The ring-like end cap 2180 also extends about the axis line 2102 and includes a skirt-like first leg 2184 that engages the corner like rim 2188 of the filter media 2130. Extending radially inward from the first leg 2184 is a second leg 2186 that is spaced apart from and generally parallel to the downstream face 2134 of the filter media 2130. To support the second leg 2186 in its spaced-apart relationship with the downstream face 2134, the end cap 2180 also includes one or more support studs 2190 that depend from the second leg to abut against the filter media 2130.

To attach the seal element 2170 to the end cap 2180 with the plurality of posts 2182, the posts extend perpendicularly from the second leg 2186 in the direction away from the filter media 2130. The posts 2182 are formed about the ring-like end cap 2180 to encircle the axis line 2102 and can be spaced-apart from each other at any suitable distance including, for example, every 2 to 3 inches. The seal element 2170 can be formed about the posts 2182 so that the posts are sandwiched between the radially outward directed sealing surface 2172 and the radially inward directed inner surface 2174. Furthermore, the bottom surface 2178 abuts against the second leg 2186 so that the seal element 2170 is axially offset from the downstream face 2134. In addition to connecting the seal element 2170 to the rest of the filter element 2112, the posts 2182 help support the seal element against the stepped surface 2160 of the filter housing 2110. In the illustrated embodiment, to assist in supporting the seal element 2170, the filter element 2112 can include a separately formed, ring-like support member 2100 that extends about and abuts against the inner surface 2174.

Also illustrated in FIG. 23 is a secondary or safety filter element 2192 located downstream of the fluted filter element 2112. The safety filter element 2192 is provided in case the fluted filter element 2112 fails or becomes displaced. The safety filter element 2192 includes a rigid support frame 2194 with a depending handle 2196 and a seal 2198 that engages the filter housing 2110.

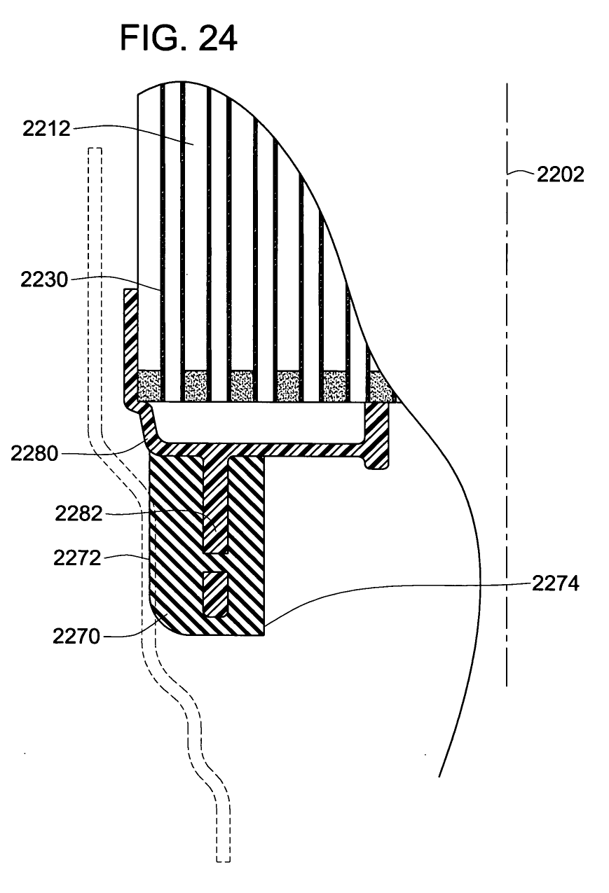

Referring to FIG. 24, there is illustrated another embodiment wherein the seal element 2270 is connected to the rest of the filter element 2212 by an end cap 2280 having a plurality of posts 2282. The seal element 2270 and end cap 2280 are similar in design to the embodiment illustrated in FIG. 23 including the plurality of posts 2282 sandwiched between a radially outward directed sealing surface 2272 and a radially inward directed inner surface 2276 of the seal element. In the illustrated embodiment, however, the posts 2282 are formed about the axis line 2202 at a closer distance to each other, such as, for example, 0.5 inches apart. Because of the reduced distance between posts 2282, it will be appreciated that the end cap 2280 will include a greater number of posts. Because the greater number of posts 2282 provides adequate support for the seal element 2270, a separate support member is unnecessary in the present embodiment.

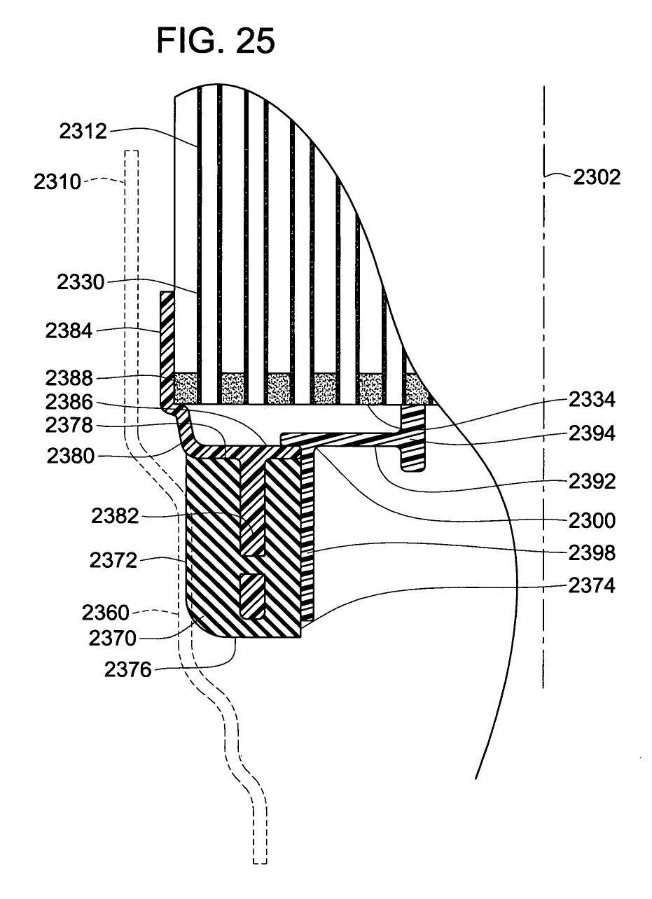

Referring to FIG. 25, there is illustrated another embodiment where the seal element 2370 is connected to the rest of the filter element 2312 by an end cap 2380 having a plurality of posts 2382. The ring-like seal element 2370 extends about the axis line 2302 and includes a radially outward directed sealing surface 2372, a spaced-apart, radially inward directed inner surface 2374, and generally parallel, spaced-apart top and bottom surfaces 2376, 2378. The ring-like end cap 2380 also extends about the axis line 2302 and includes a skirt-like first leg 2384 that engages the corner-like rim 2388 of the filter media 2330 and a second leg 2386 that extends parallel to and spaced-apart from the downstream face 2334 of the filter media 2330. The posts 2382 extend from the second leg 2386 in a direction away from the filter media 2330 and are sandwiched between the radially outward directed sealing surface 2372 and the radially inward directed inner surface 2374 of the seal element 2370. The posts 2382 can be spaced-apart from each other at any suitable distance such as, for example, every 2 to 3 inches.

To assist the posts 2382 in supporting the seal element 2370 against the stepped surface 2360 of the filter housing 2310, the filter element 2312 includes a separate support member 2300. The support member 2300 has an annular base portion 2392 that is arranged parallel to and spaced-apart from the downstream face 2334 of the filter media. To space the base portion 2392 from the downstream face 2334, one or more support studs 2394 depend from the base portion to abut against the filter media 2330. To secure the support member 2300 in place with respect to the filter media 2330, the second leg 2386 of the end cap 2380 can engage the base portion 2392. The support member 2300 also includes a ring-like support flange 2398 that extends from the base portion 2394 adjacent to the inner surface 2374, thereby supporting the seal element 2370 against the filter housing 2310.

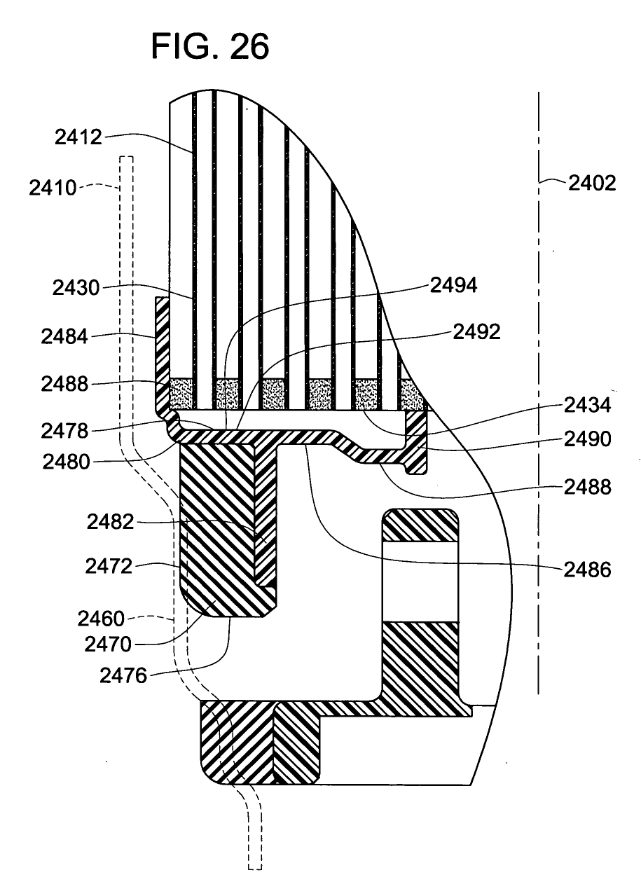

Referring to FIG. 26, there is illustrated another embodiment wherein the seal element 2470 is connected to the rest of the filter element 2412 by an end cap 2480 formed with a plurality of posts 2482. The ring-like seal element 2470 extends about the axis line 2402 and includes a radially outward directed sealing surface 2472, a spaced-apart, radially inward directed inner surface 2474, and generally parallel, spaced-apart top and bottom surfaces 2476, 2478. The ring-like end cap 2480 also extends about the axis line 2402 and includes a skirt-like first leg 2484 that engages the corner-like rim 2488 of the filter media 2430. A second leg 2486 extends from the first leg 2484 and is spaced-apart from the downstream surface 2434 of the filter media 2430 by one or more support studs 2490. Rather than extending completely parallel to the downstream face 2434, the second leg 2486 includes a raised shoulder 2488 that depends away from the filter media 2430 proximate the support stud 2490. The raised shoulder portion 2488 can provide the end cap 2480 with structural rigidity

The posts 2482 extend perpendicularly from the second leg 2486 to encircle the axis line 2402. The posts 2482 can be spaced-apart from each other at any suitable distance such as, for example, every 0.25 inches. In the illustrated embodiment, the posts 2482 extend adjacent to and abut against the inner surface 2474 of the seal element 2470 to support the seal element against the filter housing 2410. To mechanically attach the seal element 2470 to the end cap 2480, there is disposed through the second leg 2486 radially outward of the posts 2482 a plurality of apertures 2492. A flared head portion 2494 protrudes from the bottom surface 2478 of the seal element 2470 through each of the apertures 2492 to clamp the seal element to the second leg 2486.

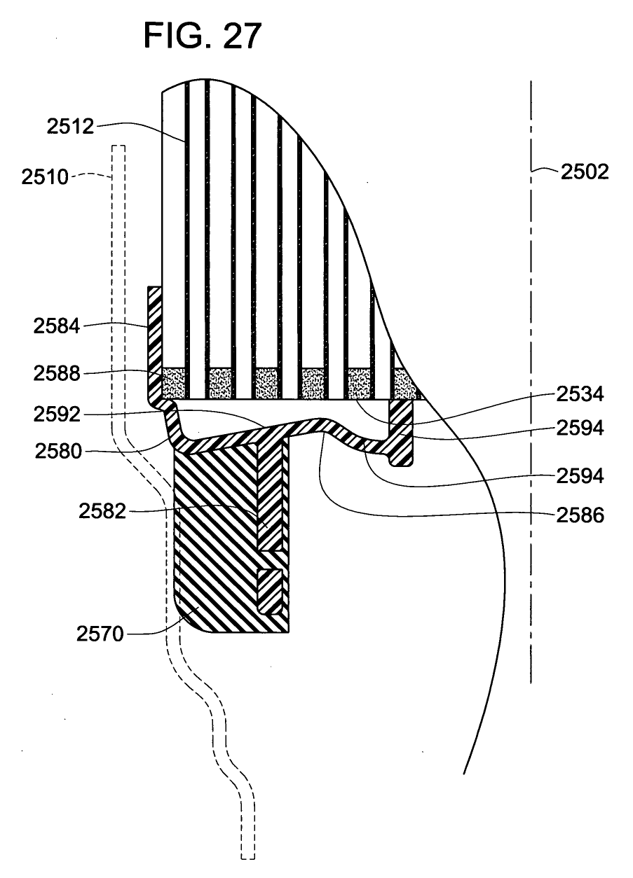

Referring to FIG. 27, there is illustrated another embodiment wherein the seal element 2570 is connected to the rest of the filter element 2512 by an end cap 2580 formed with a plurality of posts 2582. The filter element 2512 is similar in design to the embodiment illustrated in FIG. 26 and includes a ring-like end cap 2580 having a first leg 2584 engaging a corner-like rim 2588 of the filter media 2530 and a second leg 2586 spaced-apart from the downstream face 2534 by a support stud 2590. Instead of being arranged parallel to the downstream face 2534, the second leg 2586 includes a slanted portion 2592 that depends from the first leg 2584 toward the filter media 2530 and a raised shoulder portion 2594 proximate to the support stud 2590. The slanted portion 2592 and the raised shoulder portion 2594 provide the second leg with structural rigidity.

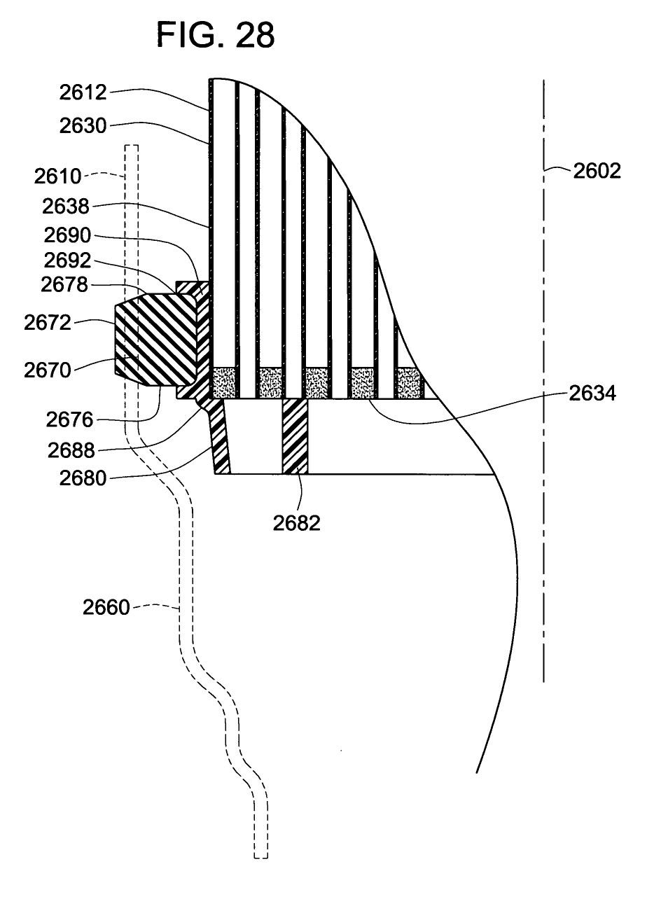

In another aspect of the invention, the seal element can be received in a slotted member for connecting the seal element to the rest of the filter element. For example, referring to FIG. 28, the ring-like seal element 2670 extends about the axis line 2602 and has a radially outward directed sealing surface 2672, a radially inward directed inner surface 2674, and generally parallel, spaced-apart top and bottom surfaces 2676, 2678. The filter element 2612 also includes a ring-like end cap 2680 that engages a corner-like rim 2688 of the filter media 2630. The end cap 2680 includes a grill plate 2682 that extends across the downstream face 2634 to assist in preventing displacement of the filter media 2630.

In the embodiment illustrated in FIG. 28, the slotted member 2690 is formed as an integral part of the end cap 2680 and extends in a skirt-like fashion adjacent to the sidewall 2638 of the filter media 2630 about the axis line 2602. The slotted member 2690 defines a radailly outward directed slot 2692 that can retentively receive the seal element 2670. Because the slotted member 2690 extends adjacent to the sidewall 2638 of the filter media 2630, both the slotted member and the seal element 2670 are situated away from the downstream face 2634 and toward the inlet of the filter housing 2610. Hence when the filter element 2612 is inserted into the filter housing 2610, the seal element 2670 is supported against the filter housing upstream of the stepped surface 2660.

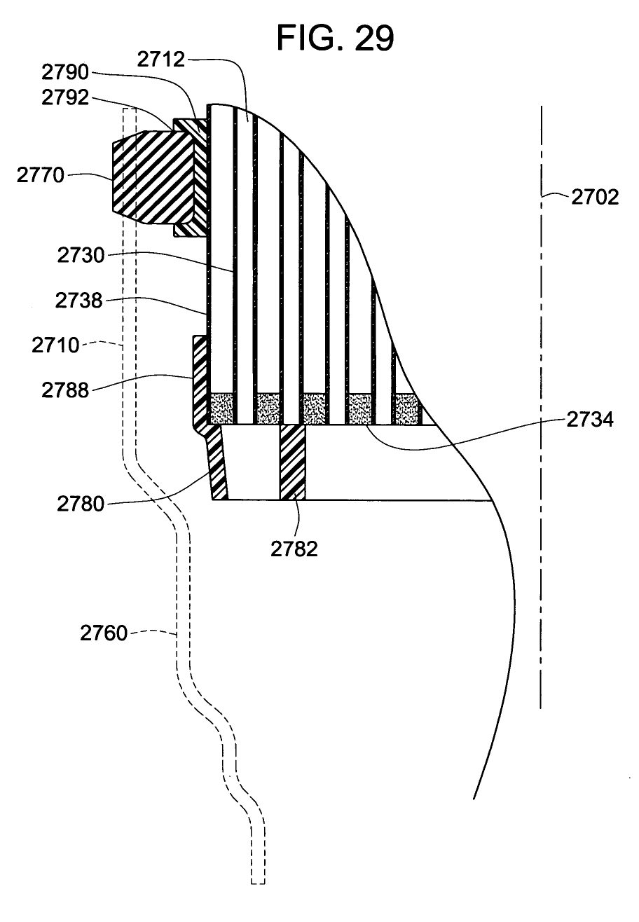

Referring to FIG. 29, in another embodiment, the seal element 2770 can be received in a slotted member 2790 that is separate from the end cap 2780. The ring-like end cap 2780 engages a corner-like rim 2788 of the filter media 2730 and includes a grill plate 2782 that extends adjacent to the downstream face 2734 to assist in preventing displacement of the filter media. The slotted member 2790 is formed as an annular band that extends adjacently about the sidewall 2738 of the filter media 2730 and defines a radially outward directed slot 2792 that can receive the seal element 2770. Furthermore, the slotted member 2790 is spaced away from the downstream face 2734 and the end cap 2780 and toward the inlet of the filter housing 2710. Hence, when the filter element 2712 is inserted into the filter housing 2710, the seal element 2770 is supported against the filter housing upstream of the stepped surface 2760.

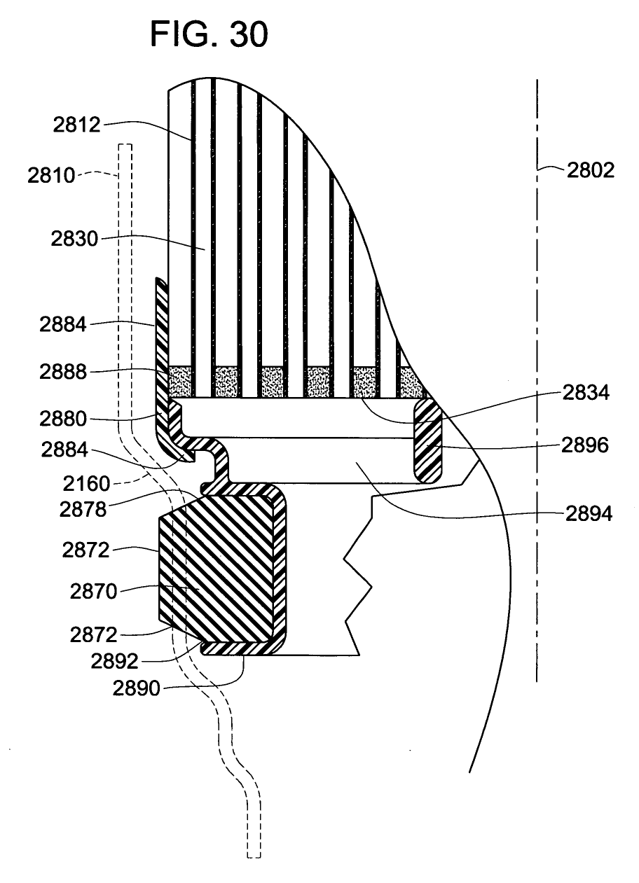

Referring to FIG. 30, there is illustrated an embodiment of a filter element 2812 in which the slotted member 2890 for connecting the seal element 2870 to the rest of the filter element is formed integrally with the grill plate 2894 but separately from the end cap 2880. The ring-like seal element 2870 has a radially outward directed sealing surface 2872, a radially inward directed inner surface 2874, and generally parallel, spaced-apart top and bottom surfaces 2876, 2878. The grill plate 2894 extends across the downstream face 2834 of the filter media 2830 and is spaced-apart therefrom by one or more support studs 2896. To secure the grill plate 2894 to the filter media 2830, the ring-like end cap 2880 includes a skirt-like first leg 2882 that engages a corner-like rim 2888 of the filter media and a radially inward projecting hook 2884 that engages the grill plate.

The slotted member 2890 is integral with and extends from the grill plate 2894 in the direction away from the downstream face 2834. Additionally, the slotted member 2890 extends as an annular band about the axis line 2802 and defines a radially outward directed slot 2892 that can receive the seal element 2870. Hence, the seal element 2870 is spaced-apart from the downstream face 2834 and, when the filter element 2812 is inserted into the filter housing 2810, is supported against the stepped surface 2860.

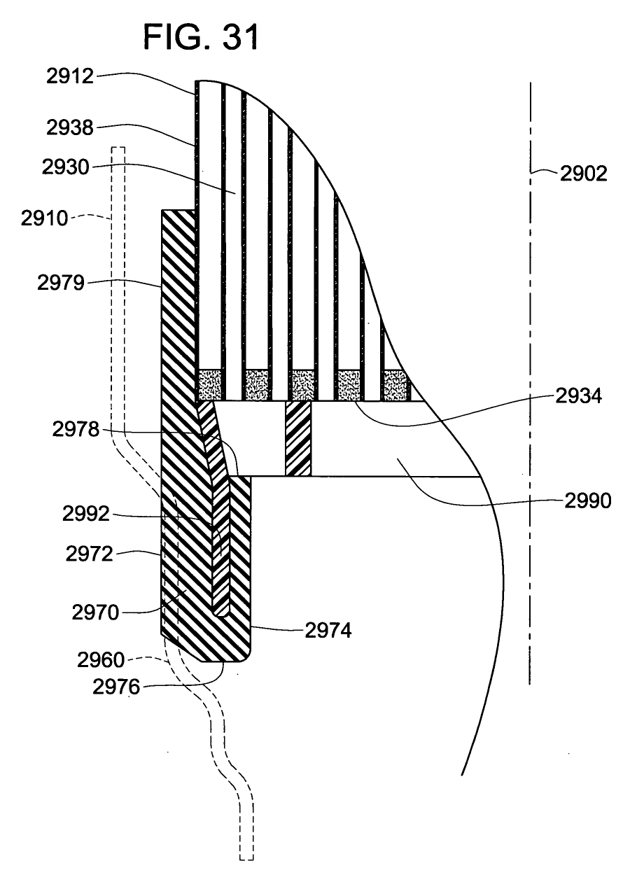

Referring to FIG. 31, there is illustrated another embodiment in which the seal element 2970 is attached directly to the filter media 2930. The ring-like seal element 2970 extends about the axis line 2902 and has a radially outward directed sealing surface 2972, a radially inward directed inner surface 2974, and generally parallel, spaced-apart top and bottom surfaces 2976, 2978. The seal element 2970 also includes a leg portion 2979 that extends from the bottom surface 2978 past the downstream face 2934 towards the upstream face and adjacently along the sidewall 2938 of the filter media 2930 and can be attached thereto by, for example, adhesive. The rest of the seal element 2970 including the top surface 2976 extends beyond the downstream face 2934 of the filter media 2930 so that the seal element can engage the stepped surface 2960 of the filter housing 2910.

To support the seal element 2970 against the filter housing 2910, the seal element can be attached to a portion of the rigid grill plate 2990. As illustrated, the grill plate 2990 extends across the downstream face 2934 to prevent the filter media 2930 from becoming displaced during use. The grill plate 2990 includes an annular flange 2992 extending away from the downstream face 2934. The seal element 2970 can be formed or molded about the flange 2992. Since the seal element 2970 is attached to the filter media 2930, the seal element additionally functions to secure the grill plate 2990 to the rest of the filter element 2912.

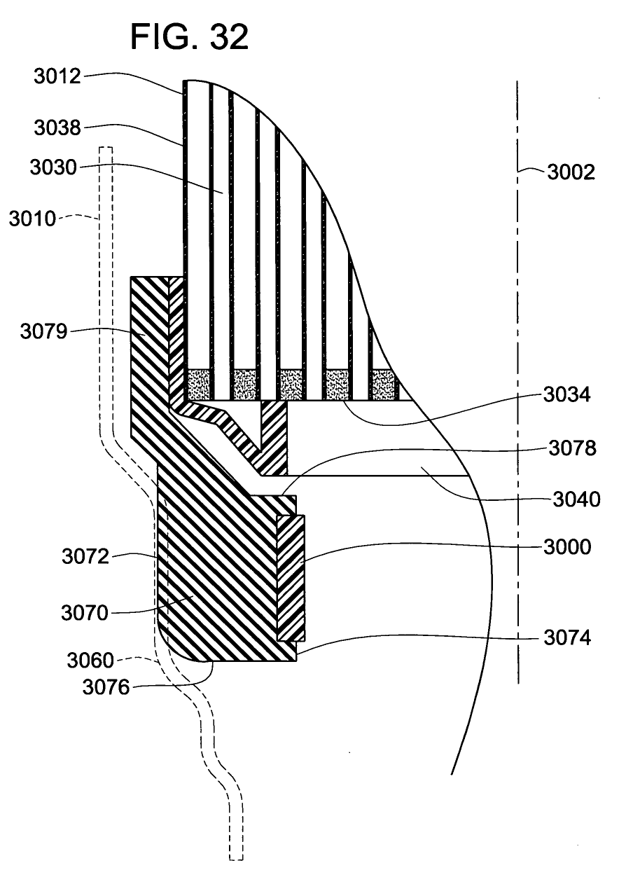

Referring to FIG. 32, there is illustrated another embodiment in which the seal element 3070 and grill plate 3090 are connected to the sidewall 3038 of the filter media 3030. The ring-like seal element 3070 includes a radially outward directed sealing surface 3072, a radially inward directed inner surface 3074, and spaced-apart top and bottom surfaces 3076, 3078. A leg portion 3079 extends in the upstream direction from the bottom surface 3078 generally along the sidewall 3038. Hence, the sealing surface 3072 and the top surface 3076 are located beyond the downstream face 3034 where they can engage the stepped surface 3060 of the filter housing 3010. To support the seal element 3070 against the filter housing, a support member 3000 in the form of an annular band can extend adjacently along the inner surface 3074 of the seal element.

The grill plate 3090 that extends across the downstream face 3034 to prevent the filter media 3030 from becoming displaced during use. Extending from the periphery of the grill plate 3090 past the downstream face 3034 and generally along the sidewall of the filter media 3030 is a second leg portion 3092. In the illustrated embodiment, the second leg portion 3092 extends between the sidewall 3038 and the first leg portion 3079 from the seal element 3070. The first and second leg portions 3079, 3092 can be adhesively attached to the filter media 3030.

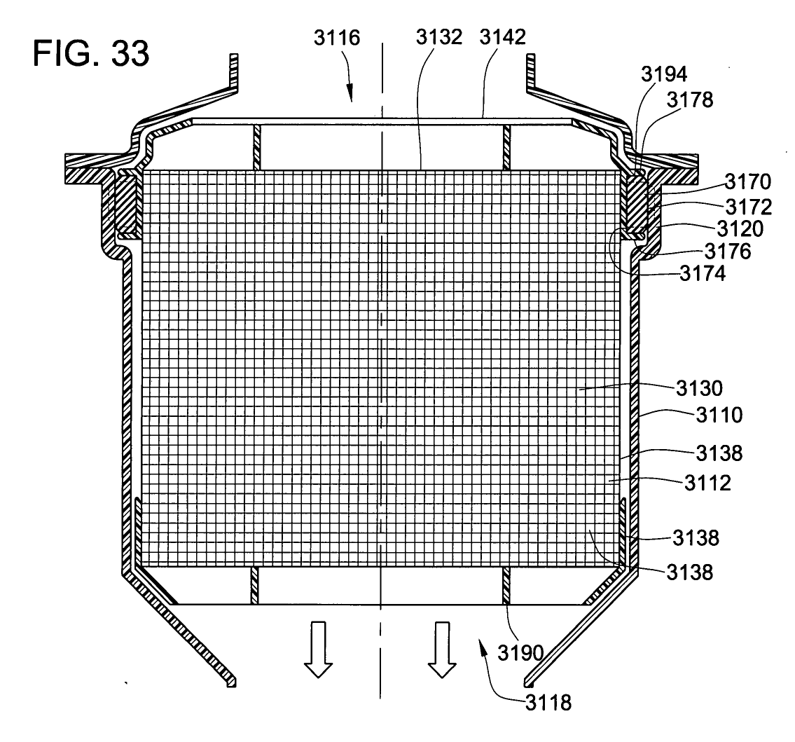

Referring to FIG. 33, there is illustrated another embodiment in which the seal element 3170 is located proximate the upstream face 3132 of the filter media 3130. The ring-like seal element 3170 includes a radially outward directed sealing surface 3172, a radially inward directed inner surface 3174, and spaced-apart top and bottom surfaces 3176, 3178. Because the seal element 3170 is located at the upstream face 3132, the seal element engages and seals against a portion of the housing 3110 near the inlet 3116. The filter housing 3110 can be formed with a counter-bore 3120 near the inlet 3116 into which the seal element 3170 can be situated. To support the seal element 3170, the filter element 3112 includes a bracket 3192 that can be connected to the upstream face 3132 of the filter media 3130. The bracket 3192 defines an annular groove 3194 that extends about the sidewall 3138 of the filter media 3130 and which can receive and maintain in position the seal element 3170. To prevent the filter media 3130 from being displaced through the outlet 3118 of the filter housing 3110 during use, an integral end cap 3180 and grill plate 3190 can be provided at the downstream face 3134 engaging a corner-like rim 3188 of the filter media 3130.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A filter element comprising:
a fluted filter media having an upstream face, an axially spaced-apart downstream face, and a plurality of fluted channels extending between the upstream and downstream faces,
an annular, compressible seal element extending about the axis and spaced-apart from the downstream face;
an annular end cap connecting the seal element to the filter media; and
an annular support member for supporting the seal element against a filter housing, the support member separately formed from the end cap.

2. The filter element of claim 1, wherein the annular seal element includes an outer sealing surface and an inner surface, and a portion of the annular support member is located between the outer sealing surface and the inner surface.

3. The filter element of claim 1, wherein the annular seal element includes an outer sealing surface and an inner surface, and a portion of the annular support member abuts against the inner surface.

4. (canceled)

5. The filter element of claim 1, wherein the end cap includes a plurality of projecting forks, and seal material of the seal element extends about the forks to mechanically attach end cap and seal element.

6. The filter element of claim 1, wherein the end cap includes an aperture disposed therein, and the seal element includes a neck portion projecting through the aperture and a flared head portion clamping the end cap to mechanically attach the end cap and seal element.

7. The filter element of claim 1, wherein the end cap includes a hollow knob, and the seal element includes a projecting plug that can be received in the void defined by the hollow knob to mechanically attach the end cap and seal element.

8. The filter element of claim 7, wherein the hollow knob includes a slot that allows seal material from the seal element to extrude about the knob.

9. The filter element of claim 1, wherein the support member has a first leg parallel to and offset from the downstream face, the support member further has a second leg extending perpendicularly from the first leg in the axial direction, the seal element being attached to the support member.

10. The filter element of claim 9, wherein the annular end cap includes an inward projecting hook extending about the first leg to secure the seal element to the filter media.

11. The filter element of claim 10, wherein the seal element includes an outer sealing surface and an inner surface, the seal element being attached to the support member so that the second leg is between outer sealing surface and the inner surface.

12. The filter element of claim 11, wherein the first leg includes an aperture disposed therein, and the seal element includes a neck portion projecting through the aperture and a flared head portion clamping the first leg to mechanically attach the support member and seal element.

13. The filter element of claim 11, wherein the first leg includes a hollow knob, and the seal element includes a projecting plug that can be received into the void defined by the hollow knob to mechanically attach the support member and seal element.

14. The filter element of claim 13, wherein the hollow knob includes a slot that allows seal material from the seal element to extrude about the knob.

15-33. (canceled)

34. A filter element comprising:
a fluted filter media defining an axis line, the fluted filter media having an upstream face, an axially spaced-apart downstream face, and a plurality of fluted channels extending between the upstream and downstream faces;
an annular compressible seal element extending about the axis line and spaced-apart from the downstream face; and
an annular end cap connecting the seal element to the filter media, the end cap including a plurality of posts for supporting the seal element against a filter housing.

35. The filter element of claim 34, wherein the posts align with and are arranged about the axis line.

36-37. (canceled)

38. The filter element of claim 35, wherein the annular seal element includes an outer sealing surface and an inner surface, and a portion of at least one post is located between the outer sealing surface and the inner surface.

39-40. (canceled)

41. The filter element of claim 35, wherein the end cap includes a skirt-like first leg engaging the filter media and a second leg parallel to and spaced-apart from the downstream face.

42. The filter element of claim 41, wherein the end cap includes an aperture disposed therein, and the seal element includes a neck portion projecting through the aperture and a flared head portion clamping the end cap to mechanically attach the end cap and seal element.

43. The filter element of claim 41, wherein the second leg includes a raised shoulder extending the support member in the axial direction.

44. The filter element of claim 41, wherein the second leg includes a slanted portion extending the support member in the axial direction.

45-60. (canceled)
